(19) United States
(12) Patent Application Publication
(10) Pub. No.: US 2025/0370602 A1
(43) Pub. Date: Dec. 4, 2025

(54) DEVICE, DISPLAY METHOD, NON-TRANSITORY RECORDING MEDIUM, AND DISPLAY SYSTEM

(71) Applicants: Ayano Inoue, KANAGAWA (JP); Susumu Fujioka, KANAGAWA (JP)

(72) Inventors: Ayano Inoue, KANAGAWA (JP); Susumu Fujioka, KANAGAWA (JP)

(73) Assignee: Ricoh Company, Ltd., Tokyo (JP)

(21) Appl. No.: 19/222,234

(22) Filed: May 29, 2025

(30) Foreign Application Priority Data
Jun. 4, 2024 (JP) 2024-090467
Mar. 24, 2025 (JP) 2025-049119

(51) Int. Cl. G06F 3/04842; G06F 3/01

(52) U.S. Cl. CPC G06F 3/04842; G06F 3/017; G06F 2203/04806

(57) ABSTRACT

A device includes circuitry to detect coordinates of a position pointed to by a pointing object, and control a display to display a part of a region where a content having the coordinates is present in a case that the coordinates are outside a display area of the display and within the region of the content.

### CROSS-REFERENCE TO RELATED APPLICATIONS

This patent application is based on and claims priority pursuant to 35 U.S.C. § 119 (a) to Japanese Patent Application Nos. 2024-090467, filed on Jun. 4, 2024 and 2025-049119, filed on Mar. 24, 2025, in the Japan Patent Office, the entire disclosure of which is hereby incorporated by reference herein.

### BACKGROUND

### Technical Field

The present disclosure relates to a device, a display method, a non-transitory recording medium, and a display system.

### Related Art

There is an electronic whiteboard that can arrange an image based on handwritten drawing data in an area that is larger than the display area of a display device such as a display, by moving the image displayed on the display device based on the handwritten drawing data to outside the display area of the display device with a swipe operation. In some cases, a large-size content such as an architectural drawing is displayed on an apparatus such as the electronic whiteboard. However, due to the limitations in the size and resolution of the display device of the apparatus, the displayed content tends to be exceedingly small and difficult to see when the entirety of the content is displayed. For this reason, when participants in a conference discuss one or multiple contents, a certain part of a region where the one or multiple contents are present is displayed first to start a discussion, and then other parts of the region are displayed as necessary.

In the art, a technique has been proposed, in which while displaying a part of the region where the contents are present, the apparatus displays the position of the region currently displayed within the entirety of the region where the contents are present. For example, a technique is disclosed that allows a user to grasp the outside of the region currently displayed by displaying an image obtained by reducing an image size of a panoramic screen region including the outside of the region currently displayed.

### SUMMARY

The present disclosure described herein provides a device including circuitry to detect coordinates of a position pointed to by a pointing object, and control a display to display a part of a region where a content having the coordinates is present in a case that the coordinates are outside a display area of the display and within the region of the content.

In another aspect, a display method includes detecting coordinates of a position pointed to by a pointing object, and controlling a display to display a part of a region where a content having the coordinates is present in a case that the coordinates are outside a display area of the display and within the region.

In another aspect, a non-transitory recording medium stores a plurality of program codes which, when executed by one or more processors, causes the one or more processors to perform the method described above.

In another aspect, a display system includes a device and an information processing apparatus communicably connected with the device. The device includes circuitry to display a content on a display, acquire information for detecting a pointing operation performed by a pointing object, and transmit the information to the information processing apparatus via a network. The information processing apparatus includes another circuitry to analyze the information received from the device, detect coordinates of a position pointed to by the pointing object performing the pointing operation, and transmit information on the coordinates to the device in a case that the coordinates are outside a display area of the display and within a region where the content having the coordinates is present. The circuitry is to control the display to display a part of the region where the content having the coordinates is present, the coordinates being included in the information received from the another circuitry.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a content displayed by a device;

FIG. 2 is a diagram illustrating a positional relationship between a region and another region on an architectural drawing;

FIG. 3 is a diagram illustrating a direction pointed to by an operator with a finger;

FIG. 4 is a diagram illustrating how a display area switching process is performed by a device;

FIG. 5 is a diagram illustrating a display example displayed on a display of a device after a display area switching process is performed;

FIG. 6 is a diagram illustrating a device used in an actual conference room;

FIG. 7 is a diagram illustrating an overall configuration of a communication system;

FIG. 8 is a diagram illustrating a hardware configuration of a device;

FIG. 9 is a block diagram illustrating a functional configuration of a device;

FIG. 10 is a diagram illustrating a table of information on object data stored in an object data storage unit;

FIG. 11 is a diagram illustrating arrangement of finger photographing cameras;

FIG. 12A is a diagram illustrating an image (right photographed image) photographed by a finger photographing camera (right);

FIG. 12B is a diagram illustrating an image (left photographed image) photographed by a finger photographing camera (left);

FIG. 13 is a front view of a display of a device;

FIG. 14 is a diagram illustrating a region where pointing position coordinates are present for which a device determines that a display area needs to be switched;

FIG. 15 is a diagram illustrating pointing position coordinates T (x1, y1) with the upper left corner of a device of a device as an origin (0, 0);

FIG. 16 is a diagram illustrating a display area switching process;

FIG. 17 is a flowchart of a process for displaying a region outside a display area in the display area in response to a gesture operation performed by an operator;

FIG. 18 is a block diagram illustrating another functional configuration of a device;

FIG. 19 is a flowchart of a process for restricting a display area switching process for a certain period of time;

FIG. 20 is a flowchart of a process for allowing a display area switching process instructed by the same operator even within a certain period of time;

FIG. 21 is a diagram illustrating an edge region in a region of a content in a direction of coordinates of a position pointed to by one finger on a display;

FIG. 22 is a diagram illustrating center coordinates Tp (xp, yp) of a display area after being switched;

FIG. 23 is a flowchart of a process for displaying a region outside a display area in the display area in response to a gesture operation performed by an operator;

FIG. 24 is a diagram illustrating a case where a device acquires image data of an architectural drawing as a content used for discussion;

FIG. 25 is a diagram illustrating a content displayed by a device after an operator performs a display operation for enlargement;

FIG. 26 is a diagram illustrating pointing position coordinates T;

FIG. 27 is a diagram illustrating a case where a device displays a part of a content together with the entirety of the content after a display area switching process is performed;

FIG. 28 is a diagram illustrating text data input to a device;

FIG. 29 is a diagram illustrating ideas input by participants;

FIG. 30 is a diagram illustrating a case where participants in a conference add ideas to measures already displayed by a device;

FIG. 31 is a diagram illustrating a relationship between an overall view of a mind map and a display area of a device;

FIG. 32 is a diagram illustrating pointing position coordinates T detected on the overall view of a mind map;

FIG. 33 is a diagram illustrating a display example after a display area switching process is performed;

FIG. 34 is a diagram illustrating a configuration of a display system;

FIG. 35 is a block diagram illustrating a hardware configuration of an information processing apparatus;

FIG. 36 is a block diagram illustrating a functional configuration of a display system;

FIG. 37 is a sequence diagram illustrating a process in which a device and an information processing apparatus communicate with each other to display a region at a position pointed to by an operator with a finger;

FIG. 38 is a diagram illustrating display of a device on which a pointing position illustration image is displayed; and

FIGS. 39A and 39B are flowcharts of another process for displaying a region outside a display area in the display area in response to a gesture operation performed by an operator. The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A device and a display method performed by the device are described below with reference to the drawings.

### Terminology

A pointing object may be any object that performs a gesture operation that can be recognized by a device. Examples of the pointing object include a human hand, a pointing stick, an artificial hand, another object similar to any one of the aforementioned articles, a humanoid robot, and a non-humanoid robot.

Information used for detecting a pointing operation performed by the pointing object is information that the pointing object can indicate for the pointing operation to be detected. The information used for detecting the pointing operation performed by the pointing object includes, for example, at least one of two-dimensional luminance information such as image data and a three-dimensional shape. In the present embodiment, the pointing operation is described in terms of a gesture operation.

The gesture refers to a body language expressed by a motion of a body and refers to a body movement or a hand movement. In the present embodiment, an operator operates the device by gesture, and the operation of the device by gesture is referred to as a gesture operation.

The device is an electronic device that recognizes the gesture operation and receives an operation intended by the gesture operation. The term device is sometimes used in contrast to the term an instrument or tool having a simple structure. In the present embodiment, an electronic whiteboard is sometimes used as an example of the device.

A content is contained in data and is displayed based on the data. As long as the content can be displayed by the device based on the data, any content and any file format of data, such as a joint photographic experts group (JPEG) format, a graphic interchange format (GIF), a portable document format (PDF), a WORD format, an EXCEL format, a three-dimensional (3D) software project file format, may be used. In the present embodiment, the content is an architectural drawing, which is given by way of example.

A display device may be any device or component that displays the content. The display device may be a display or a monitor. Alternatively, the display device may be a device that projects and displays the content, such as a projector.

### First Embodiment

A usage scene in which the operator operates the device to display a content that is large in size is described below. The operator enters a conference room to conduct a conference. When the operator enters the conference room, the operator operates the device to display the content to be used in the conference on a display included in the device. The content is, for example, an architectural drawing in a file in the PDF created on the assumption of A0 or A1 size. The file format is not limited to the PDF. Also, the size is not limited to the A0 or A1 size. The present embodiment can be suitably applied to a case where the device displays a content larger in size than the display area of the display included in the device.

The device executes a cloud file sharing application and downloads the content uploaded in the cloud in advance using a cloud service. Alternatively, the device may read out the content from an external memory, or may receive the content transmitted from a communication terminal such as a personal computer (PC) via wired or wireless communication. When the device is ready to display the content, the device displays an overall view of the content on the display.

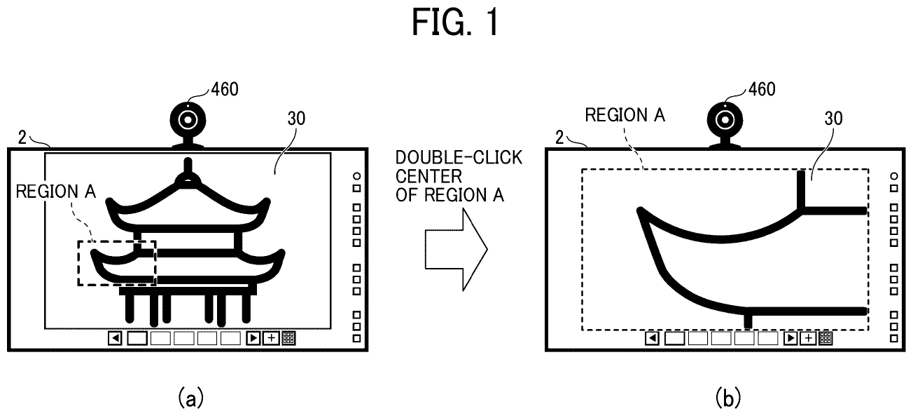

FIG. 1 is a diagram illustrating a content 30 displayed in a reduced size by a device 2. The operator who is the organizer of the conference starts the conference using the content 30 displayed by the device 2 in the conference room. The entirety of the content 30 is displayed in the display area of the display of the device 2. The display area is an area in which a region where pixels are present is set to the maximum and parts where the content 30 cannot be displayed due to, for example, menu windows are excluded. The display area is, for example, an area where the content 30 can be displayed. As illustrated in part (a) of FIG. 1, the operator and participants in the conference in the conference room can check the overall view of the architectural drawing by looking at the device 2.

The operator initiates a discussion of a specific part of the architectural drawing. The specific part is referred to as a region A. At this point, since the device 2 is displaying the entirety of the architectural drawing, the region A needs to be enlarged so that the details of the region A can be checked. The enlargement in this case means displaying the pixel data in the memory corresponding to the region A as it is, without involving enlargement processing of the display data such as pixel interpolation. The operator double-clicks the center of the region A on the architectural drawing so that the region A that is the subject of the discussion is displayed.

In part (B) of FIG. 1, the region A in the architectural drawing data stored in the memory is illustrated. The region A that is the subject of the discussion is displayed on the display in response to the double-clicking performed by the operator and the details of the architectural drawing can be checked. Thus, the operator can proceed with the discussion on the region A while being seated away from the device 2.

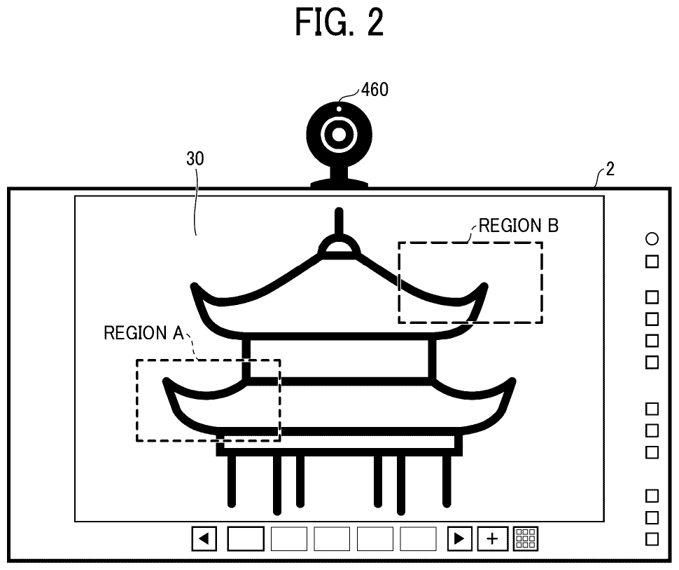

FIG. 2 is a diagram illustrating a positional relationship between the region A and a region B on the architectural drawing. The operator concludes the discussion on the region A and then proceeds with another discussion on the region B. The region B is located to the upper right of the region A on the architectural drawing. The device 2 is currently displaying the region A in an enlarged size, and the region B is not displayed on the display. At this time, in order for the region B that is not displayed to be displayed on the display of the device 2, the operator points with a finger to a region where the region B that is outside the display area of the display of the device 2 is present while the region A is being displayed. Such an operation is called a gesture operation.

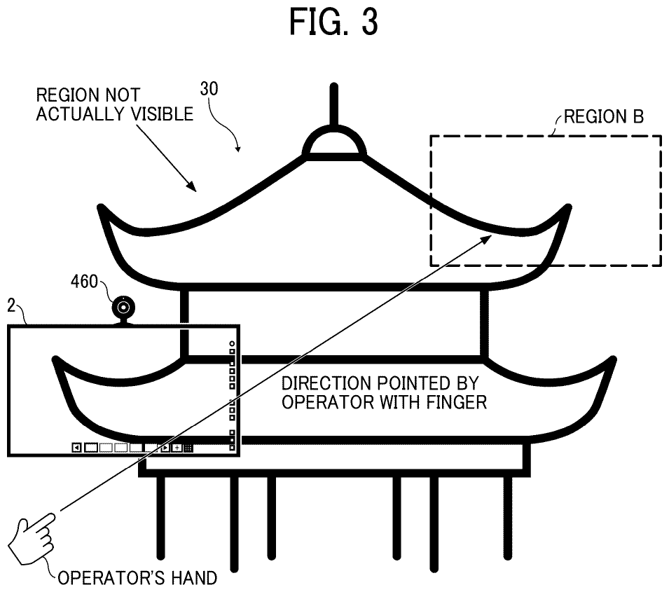

FIG. 3 is a diagram illustrating a direction pointed to by the operator with a finger. The device 2 includes a built-in or external finger photographing camera, and photographs a region in front of the device 2 including the operator pointing with the finger to the region B. The finger photographing camera transmits image data obtained by photographing the region to the device 2. In response to receiving the image data, the device 2 executes image processing on the image data and performs an identifying process to identify pointing position coordinates with the upper left corner of the display area of the display of the device 2 as an origin (i.e., reference coordinates). The pointing position coordinates are expressed by the number of pixels in the x-axis direction and the number of pixels in the y-axis direction from the origin. The identifying process to identify the pointing position coordinates is executed on a two-dimensional plane extending from the display of the device 2. Although the pointing position coordinates are present in the region outside the display, the pointing position coordinates are expressed in the same coordinate system as within the display. When completing the identifying process to identify the pointing position coordinates using the image data, the device 2 performs a display area switching process to switch the display area to the periphery of the pointing position coordinates.

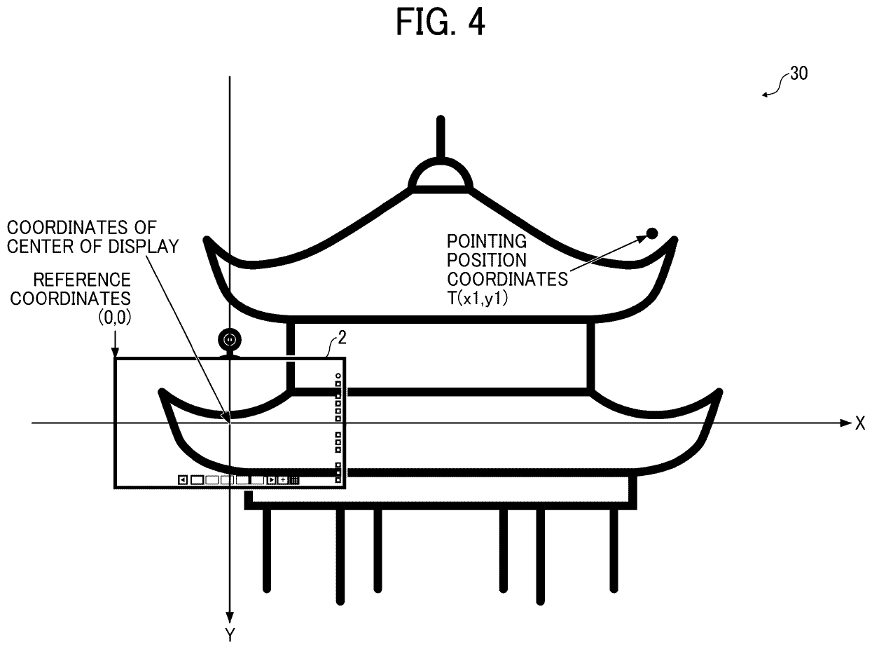

FIG. 4 is a diagram illustrating how the display area switching process is performed by the display 2. Assuming that the pointing position coordinates are coordinates (x1, y1), the display area switching process is a process to move the coordinates (x1, y1) to the center position of the display of the device 2 at the current time. When completing the display area switching process, the device 2 displays, on the display of the device 2, the region B corresponding to the position pointed to by the finger on the architectural drawing.

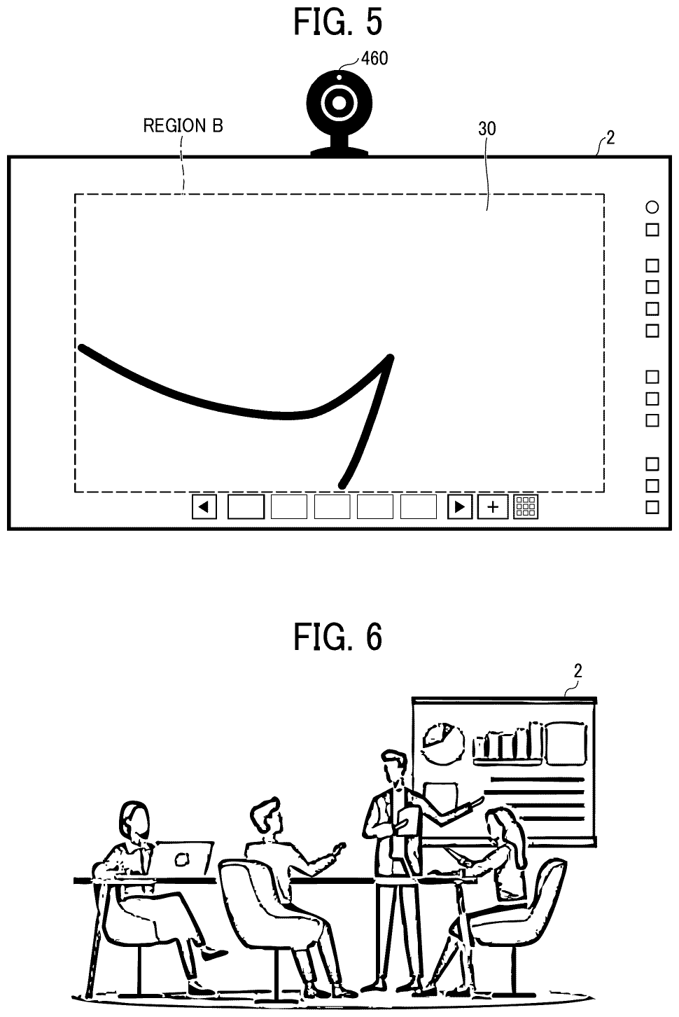

FIG. 5 is a diagram illustrating a display example displayed on the display of the device 2 after the display area switching process is performed. On the display, the region B is being displayed. The device 2 does not perform the display area switching process for five seconds after switching to the region B. The period of time of five seconds is given by way of example, and can be set by the operator as desired. In this way, the display area is prevented from being switched by pointing performed by another operator with a finger immediately after the display area is switched by the pointing performed by the operator with the finger.

As described above, the device 2 according to the present embodiment does not need to reduce the size of the content 30 once so that the entirety of the content 30 is displayed or move the display area with swiping in order to display the region not displayed on the display. In addition, the operator can operate the device 2 to display a desired display area on the display by performing a gesture operation while being away from the device 2.

### Configuration of System

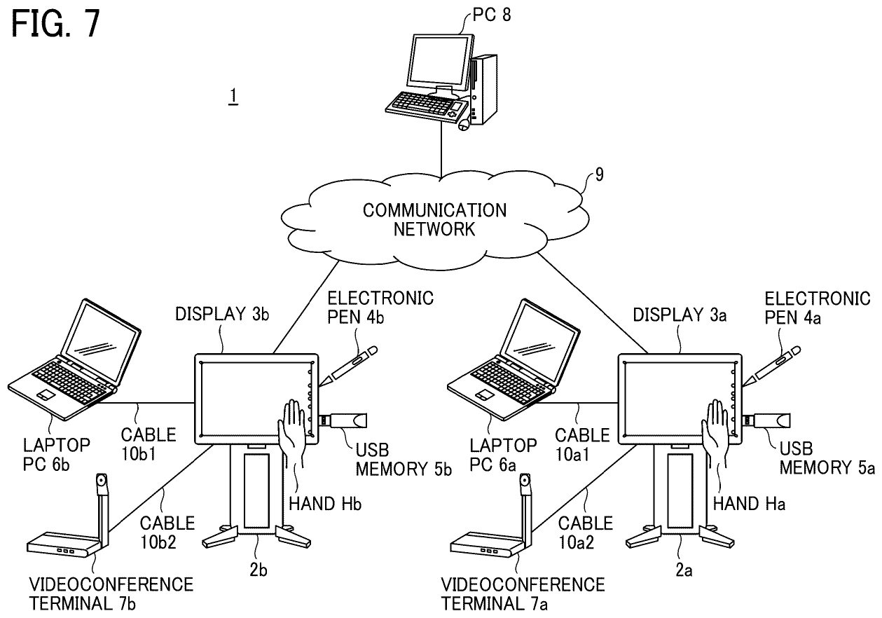

FIG. 6 is a diagram illustrating the device 2 used in an actual conference room. In FIG. 6, the device 2 is arranged in a conference room, and participants are seated at a table in front of the device 2. If the display area switching process or writing can be performed with a gesture operation while the participants are seated as described above, the range of usage will be expanded. For example, when a participant says “the upper right of the drawing” while pointing to the upper right of the drawing with a finger to explain the region of the drawing being not displayed, the other participants may not understand in some cases. In these cases, the participant has to move to in front of the device 2 and perform a swipe operation to move the display area. In the present embodiment, since the display area switching process is performed while the participant is seated, the need for the participant to move to in front of the device 2 is reduced.

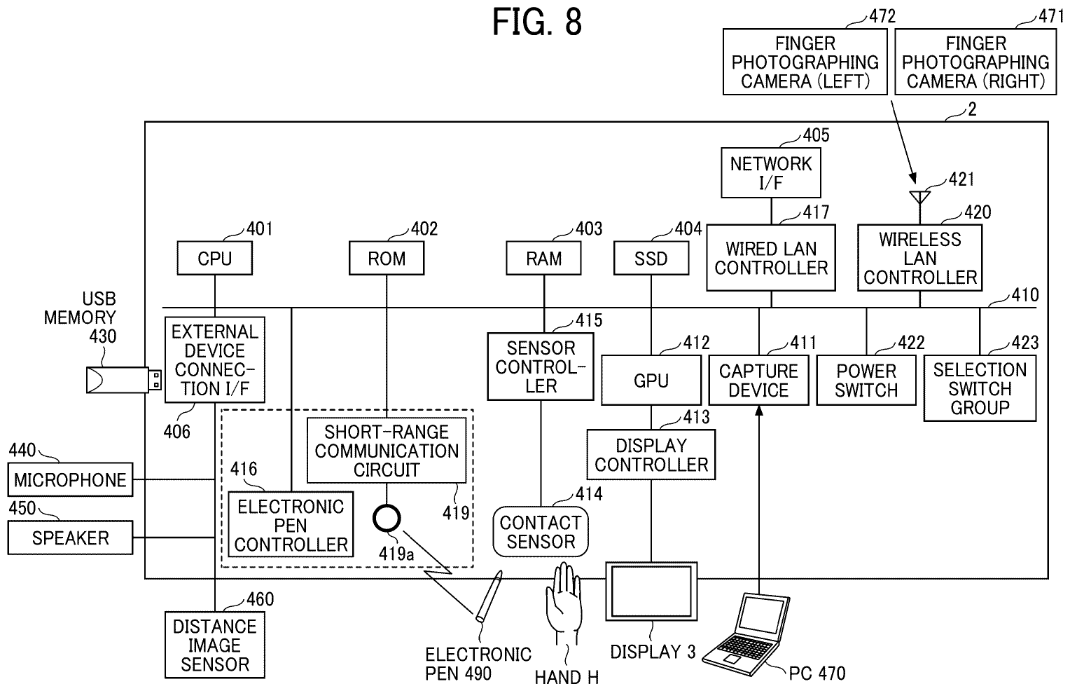

FIG. 7 is a diagram illustrating an overall configuration of a communication system 1. In FIG. 7, for the sake of simplicity, the communication system 1 includes only two devices 2a and 2b and two electronic pens 4a and 4b bundled with the two devices 2a and 2b, respectively. However, the numbers of devices and electronic pens may be three or more.

As illustrated in FIG. 7, the communication system 1 includes the multiple devices 2a and 2b, the multiple electronic pens 4a and 4b, multiple universal serial bus (USB) memories 5a and 5b, multiple laptop personal computers (PCs) 6a and 6b, multiple videoconference (teleconference) terminals 7a and 7b, and a personal computer (PC) 8. The devices 2a and 2b and the PC 8 are connected to each other via a communication network 9 to communicate with each other. The multiple devices 2a and 2b are provided with displays 3a and 3b each having a touch sensor, respectively.

The device 2a displays, on the display 3a, an image drawn by an event caused by the electronic pen 4a. The event is, for example, a touch of the tip or bottom of the electronic pen 4a onto the display 3a. In addition, the device 2a changes the image displayed on the display 3a based on an event caused by not only the electronic pen 4a but also, for example, a hand Ha of the operator touching the display 3a. The event caused by the hand Ha is, for example, a gesture operation such as enlargement, reduction, or page switching.

The USB memory 5a is connectable to the device 2a. The device 2a reads out an electronic file described in, for example, the PDF from the USB memory 5a and stores an electronic file in the USB memory 5a. The device 2a includes an interface conforming to a communication standard such as DISPLAYPORT, a digital visual interface (DVI), HIGH-DEFINITION MULTIMEDIA INTERFACE (HDMI), or Video Graphics Array (VGA). The operator uses a cable 10a1 conforming to the standard to connect the laptop PC 6a to the device 2a.

On the device 2a, an event is caused by an operation performed by the operator contacting with the display 3a (screen). The device 2a transmits event information indicating the event to the laptop PC 6a in a manner similar to transmitting information on an event caused by an input device such as a mouse or a keyboard. In substantially the same manner, the videoconference terminal (teleconference terminal) 7a is connected to the device 2a via a cable 10a2 that allows communication in compliance with the above-described standard. Alternatively, the laptop PC 6a and the videoconference terminal 7a may communicate with the device 2a through wireless communication in compliance with any one of various wireless communication protocols, such as WIRELESS FIDELITY (Wi-Fi).

At another site where the device 2b is arranged, the device 2b provided with the display 3b, the electronic pen 4b, the USB memory 5b, the laptop PC 6b, the videoconference terminal 7b, a cable 10b1, and a cable 10b2 in a similar manner to the above is used. The device 2b changes an image displayed on the display 3b based on an event caused by a hand Hb of another operator touching the display 3b.

With this configuration, an image drawn on the display 3a of the device 2a at a site is displayed on the display 3b of the device 2b at the other site. Conversely, an image drawn on the display 3b of the device 2b at the other site is displayed on the display 3a of the device 2a at the site. Since the communication system 1 performs processing for remotely sharing the same image between remote locations in this manner, the communication system 1 is especially useful when used in a conference held across the remote locations.

In the following description, the multiple devices 2a and 2b are collectively referred to as devices 2, and any one of the devices 2 is referred to as a “device 2” unless particularly distinguished from each other. The displays 3a and 3b are collectively referred to as displays 3, and any one of the displays 3 is referred to as a “display 3” unless particularly distinguished from each other. The multiple electronic pens 4a and 4b are collectively referred to as electronic pens 4, and any one of the electronic pens 4 is referred to as an “electronic pen 4” unless particularly distinguished from each other. The USB memories 5a and 5b are collectively referred to as USB memories 5, and any one of the USB memories 5 is referred to as a “USB memory 5” unless particularly distinguished from each other. The laptop PCs 6a and 6b are collectively referred to as laptop PCs 6, and any one of the laptop PCs 6 is referred to as a “laptop PC 6” unless particularly distinguished from each other. The videoconference terminals 7a and 7b are collectively referred to as videoconference terminals 7, and any one of the videoconference terminals 7 is referred to as a “videoconference terminal 7” unless particularly distinguished from each other. The hand Ha of the operator and the hand Hb of the other operator 7b are collectively referred to as hands H, and any one of the hands H is referred to as a “hand H” unless particularly distinguished from each other. The cables 10a1, 10a2, 10b1, and 10b2 are collectively referred to as cables 10, and any one of the cables is referred to as a “cable 10” unless particularly distinguished from one another.

In the present embodiment, the electronic whiteboard is described as one example of the device 2, but the device 2 is not limited thereto. Other examples of the device 2 include an electronic signboard (digital signage), a telestrator that is used, for example, in sports and weather broadcasts, and a remote image (video) diagnostic apparatus. The telestrator is a technology that synthesizes handwriting with an image displayed on a monitor. The device 2 may also be a headset device such as a virtual reality (VR) goggle, augmented reality (AR) goggle, or mixed reality (MR) goggle.

Similarly, the laptop PC 6 is described as one example of an external device, but the external device is not limited thereto. The external device may be any communication terminal that provides an image frame such as a desktop PC, a tablet PC, a smartphone, a digital video camera, a digital camera, or a game console. Further, the communication network includes, for example, the Internet, a local area network (LAN), and a mobile communication network. In the present embodiment, the USB memory is described as one example of a recording medium, but the recording medium is not limited thereto. The recording medium may be any type of a recording medium, such as a secure digital (SD) card.

### Hardware Configuration

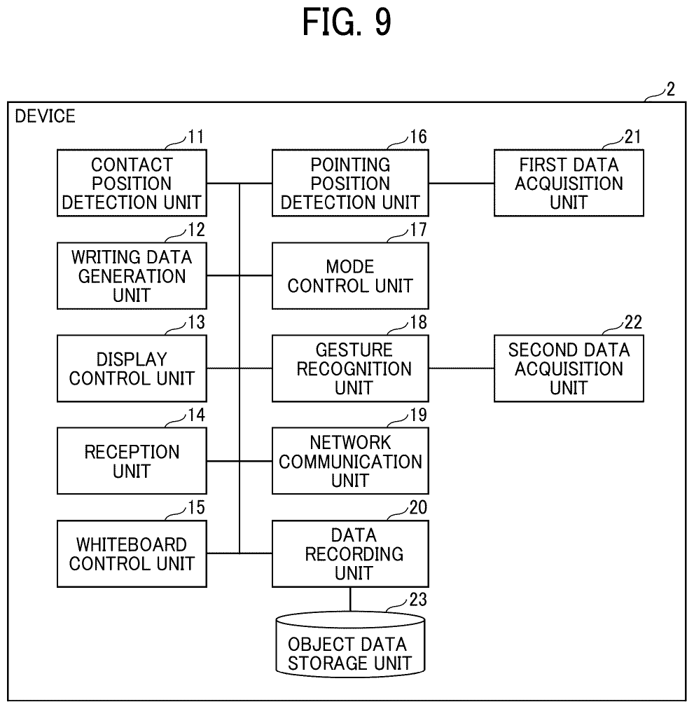

FIG. 8 is a diagram illustrating a hardware configuration of the device 2. As illustrated in FIG. 8, the device 2 includes a central processing unit (CPU) 401, a read-only memory (ROM) 402, a random-access memory (RAM) 403, a solid-state drive (SSD) 404, a wired LAN controller 417, a network interface (I/F) 405, a wireless LAN controller 420, an antenna 421, and an external device connection I/F 406.

The CPU 401 controls the entire operation of the device 2. The ROM 402 stores a program such as an initial program loader (IPL) used for booting an operating system (OS). The RAM 403 is used as a work area for the CPU 401. The SSD 404 stores various data such as a program used for the device 2. The wired LAN controller 417 controls communication with other devices connected to the communication network 9 via the network I/F 405, which may be implemented by an interface circuit. The wireless LAN controller 420 executes a communication protocol conforming to, for example, the Institute of Electrical and Electronics Engineers (IEEE) 802.11ax standard, and controls the communication with a finger photographing camera (right) 471 and a finger photographing camera (left) 472 by transmitting and receiving radio waves via the antenna 421. The external device connection I/F 406, which may be implemented by an interface circuit, is an interface that controls communication of data with various external devices. Examples of the external devices include, but not limited to, a USB memory 430, a microphone 440, a speaker 450, and a distance image sensor 460. These external devices may be included in the device 2.

The distance image sensor 460 has a structure in which, for example, 500 pairs of infrared laser diodes and light-receiving elements are arranged in the vertical direction and the horizontal direction, respectively, and measures a distance based on the time from when the infrared laser diodes emit light to when the reflected light is received. Accordingly, the distance image sensor 460 outputs 500 by 500 pieces of distance data as an image of one frame at a speed of 30 to 60 frames per second (fps). The distance image sensor 460 may be a stereo camera or a light detection and ranging (LiDAR) sensor. The distance image data may contain at least one of distance data and image data. In the following description, the distance image data may be referred to simply as image data.

The finger photographing camera (right) 471 and the finger photographing camera (left) 472 are photographing devices that photograph a finger pointed out by the operator to specify a region outside the display area of the display 3. As will be described later, the finger photographing camera (right) 471 photographs the finger from the right, and the finger photographing camera (left) 472 photographs the finger from the left. The finger photographing camera (right) 471 and the finger photographing camera (left) 472 transmit the photographed image data to the device 2 through a wireless LAN, respectively. The finger photographing camera (right) 471 and the finger photographing camera (left) 472 may transmit the photographed image data to the device 2 through a wired LAN, respectively.

The device 2 also includes a capture device 411, a graphics processing unit (GPU) 412, a display controller 413, a contact sensor 414, a sensor controller 415, an electronic pen controller 416, a short-range communication circuit 419, an antenna 419a of the short-range communication circuit 419, a power switch 422, and a selection switch group 423.

The capture device 411 acquires display information of an external PC 470 to display a still image or a video based on the display information. The GPU 412 is a semiconductor chip dedicated to processing of a graphical image. The display controller 413 controls screen display to output an image processed by the GPU 412 to, for example, the display 3. The contact sensor 414 detects a touch onto the display 3 with, for example, the electronic pen 4 or the hand H of the operator. The sensor controller 415 performs an identifying process to identify contact coordinates based on the signal transmitted from the contact sensor 414. The contact sensor 414 detects input in coordinates and identifies the coordinates using an infrared blocking system. To detect input in coordinates and identify the coordinates, two light receiving and emitting devices arranged at both ends of the upper face of the display 3, respectively, are used. A light-emitting element such as a laser included in each of the two light receiving and emitting devices performs scanning by emitting an infrared beam and rotating the infrared beam in a range of 90 degrees in parallel to the surface of the display 3. The infrared beam is reflected by a reflecting member arranged at the surrounding of the display 3. A light-receiving element included in each of the light receiving and emitting devices receives light (i.e., the infrared beam) returning through the same optical path of the emitted infrared beam. Each of the two light receiving and emitting devices that serve as the contact sensor 414 outputs, to the sensor controller 415, position information (a position on the light-receiving element) of the infrared beam that is emitted from each of the two light receiving and emitting devices and then blocked by an object. Based on two pieces of the position information received by the two light receiving and emitting devices, respectively, the sensor controller 415 identifies the coordinates of the position contacted by the object. The electronic pen controller 416 determines whether the tip or bottom of the electronic pen 4 has touched onto the display of the display 3, based on data input by the short-range communication circuit 419 communicating with the electronic pen 4 via BLUETOOTH. The short-range communication circuit 419 is a communication circuit in compliance with, for example, the near field communication (NFC) or BLUETOOTH. The power switch 422 is a switch that turns on or off the power of the device 2. The selection switch group 423 is, for example, a group of switches for adjusting brightness, hue, etc., of display on the display 3.

The device 2 further includes a bus line 410. The bus line 410 is, for example, an address bus or a data bus that electrically connects the elements illustrated in FIG. 8, such as the CPU 401, with one another.

The detector of the contact sensor 414 is not limited to the infrared blocking system. The contact sensor 414 may employ, as the detector, a capacitive touch panel that detects a change in capacitance to identify a contact position. Alternatively, the contact sensor 414 may employ, as the detector, a resistance film touch panel that detects a change in voltage of two opposing resistance films to identify a contact position. Still alternatively, the contact sensor 414 may employ, as the detector, an electromagnetic induction touch panel that detects electromagnetic induction caused by contact of an object onto the display to identify a contact position. In addition to the devices described above, any one of various other types of detection devices may be used as the contact sensor 414. In addition to or alternative to detecting a touch by the tip or bottom of the electronic pen 4, the electronic pen controller 416 may also detect a touch by another part of the electronic pen 4, such as a part held by the hand of the operator.

### Functions

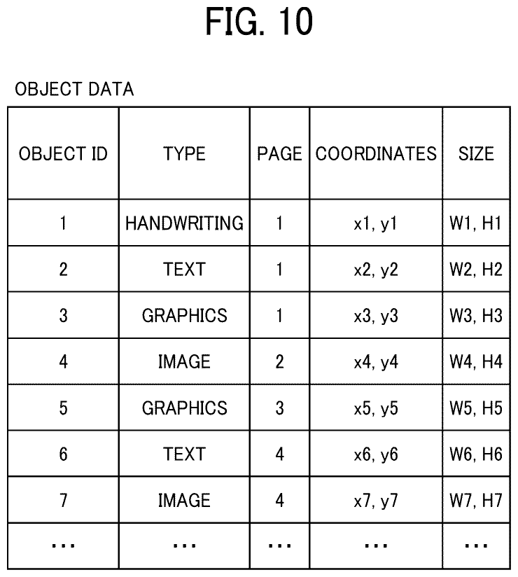

The functions of the device 2 is described below with reference to FIG. 9. FIG. 9 is a block diagram illustrating a functional configuration of the device 2. The device 2 includes a contact position detection unit 11, a writing data generation unit 12, a display control unit 13, a reception unit 14, a whiteboard control unit 15, a pointing position detection unit 16, a mode control unit 17, a gesture recognition unit 18, a network communication unit 19, a data recording unit 20, a first data acquisition unit 21, a second data acquisition unit 22, and an object data storage unit 23.

The contact position detection unit 11 converts a position touched by the pen or the finger into coordinates. The writing data generation unit 12 acquires the coordinates of the position touched by the tip of the pen or finger from the contact position detection unit 11. The writing data generation unit 12 acquires coordinates of a position pointed to by the operator with one finger from the pointing position detection unit 16. The writing data generation unit 12 interpolates these coordinate point sequences to generate a writing line. The writing line input to the touch panel by the handwriting with the pen or finger is displayed on the display 3.

The display control unit 13 controls the display 3 to display, for example, the writing line, text converted from the writing line, and an operation menu for the operator to operate. The display control unit 13 is a unit that controls the display 3 to display a part of a content present at the coordinates detected by the pointing position detection unit 16. The part of the content present at the coordinates refers to the part of the content pointed to by the operator with the finger. When the display area switching process is performed, the display control unit 13 controls the display 3 to display a region including the pointing position coordinates.

The reception unit 14 receives a press of a menu based on the coordinates of the position touched by the pen or the finger or the coordinates detected by the pointing position detection unit 16.

The whiteboard control unit 15 performs the overall control of a whiteboard application such as activation of the whiteboard application, authentication, menu display, communication with a remote location, and data storage.

The first data acquisition unit 21 is a unit that acquires image data obtained by photographing the hand of the operator and the display 3 of the device. The hand of the operator refers to the hand of the operator pointing to the display 3 of the device with the finger. The first data acquisition unit 21 acquires image data from the finger photographing camera (right) 471 and the finger photographing camera (left) 472, respectively.

The pointing position detection unit 16 is a unit that detects the coordinates of a position pointed to by a gesture operation performed by the operator. The gesture operation is, for example, extending one finger. For example, the pointing position detection unit 16 analyzes respective pieces of image data captured by the finger photographing camera (right) 471 and the finger photographing camera (left) 472, and detects coordinates of a position pointed to by the finger of the operator performing a gesture operation, which is outside the area of the display 3 and within the region of the content 30. Specifically, the pointing position detection unit 16 analyzes the image data acquired by the first data acquisition unit 21, and detects the coordinates of the intersection point of the extension line of the one finger extended by the operator and the face of the display 3. In this way, the display area of the display 3 is switched by the operator performing the gesture operation.

The mode control unit 17 controls the transition of a mode based on the gesture operation recognized by the gesture recognition unit 18. The mode transitions from the initial state to a gesture recognition mode, and from the gesture recognition mode to the initial state. Alternatively, the mode may transition, for example, in response to an operation to a menu instead of a gesture operation.

The second data acquisition unit 22 is a unit that acquires, from a sensor that acquires information on the state of the hand of the operator, the information. The distance image data may include information on the shape of the hand of the operator, which is a three-dimensional shape. The information on the state of the hand of the operator is at least one of luminance information and distance information (i.e., three-dimensional information). Specifically, the second data acquisition unit 22 acquires the distance image data from the distance image sensor 460.

The gesture recognition unit 18 is a unit that analyzes the information on the state of the hand acquired by the distance image sensor 460 to recognize a gesture operation. The information on the state of the hand includes at least one of an image and a three-dimensional shape. The gesture recognition unit 18 obtains, using the distance image sensor, shape data of the palm of the hand from the distance image obtained by photographing the palm of the hand, and stores this shape data in a hard disk. The palms of the hands of many people are photographed, and the shape data of many of the palms of the hands is stored in the hard disk.

The gesture recognition unit 18 first performs a process to recognize the palm of the hand. The gesture recognition unit 18 detects a moving object in the distance image input from the distance image sensor, and compares the shape data of the moving object with the shape data of the palms of the hands stored in advance to determine that the moving object is the palm of the hand. This determination is made based on a model generated by learning palm shape data of many palms of hands. When the gesture recognition unit 18 recognizes the palm of the hand, the mode control unit 17 controls the mode to transition to the gesture recognition mode.

When the mode transitions to the gesture recognition mode, the gesture recognition unit 18 tracks the movement of the object representing the palm of the hand and recognizes that the object has changed to a shape of an extended index finger. The index finger sometimes referred to as a one finger in the following description. The gesture recognition unit 18 determines that the gesture is a gesture for specifying a position pointed to by the finger on the display 3 or on the plane extending from the display 3. When the gesture recognition unit 18 recognizes that the shape of the hand pointing with the one finger changes to a shape of the hand folding the one finger (i.e., clenching the fingers), the gesture recognition unit 18 determines that the gesture is a gesture operation to end specifying the position. While recognizing the shape of the hand pointing with the one finger, the gesture recognition unit 18 requests the pointing position detection unit 16 to detect the pointing position coordinates of the position pointed to by the one finger.

The network communication unit 19 is connected to the communication network 9 to perform data communication with the other device 2, a desired server apparatus, and other external devices.

The data recording unit 20 causes the object data storage unit 23 to store, for example, handwritten data handwritten on the display of the device 2, text data converted from the handwritten data, screens of the PC, and files.

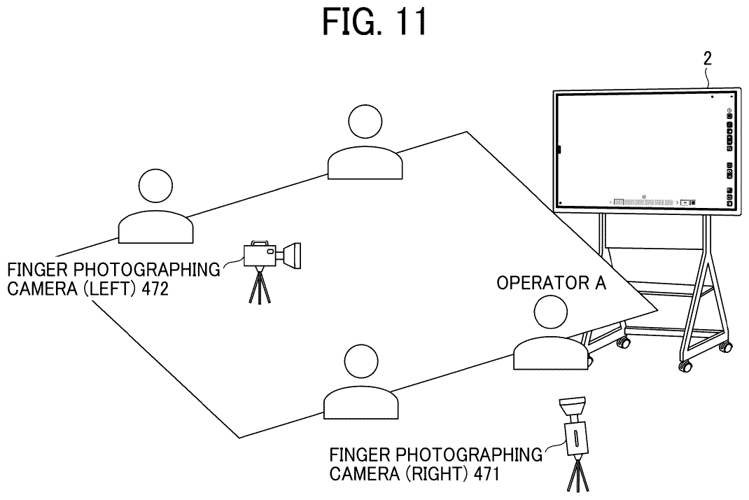

FIG. 10 is a diagram illustrating a table of information on object data stored in the object data storage unit 23. The item “object identification (ID)” is identification information for identifying display data. The item “type” is a type of object data. The examples of the type include handwriting, text, graphics, an image, and a table. The handwriting indicates stroke data (coordinate point sequence). The text indicates one or more characters or symbols, such as a character code, converted from handwritten data. The graphics indicates a geometric shape registered in a menu and selected by the operator, or converted from handwritten data, such as a triangle or a rectangle. The image indicates image data in a format such as Joint Photographic Experts Group (JPEG), Portable Network Graphics (PNG), or Tagged Image File Format (TIFF) acquired from, for example, a PC or the Internet. The table indicates a one-dimensional or two-dimensional object in the form of a table. The item “coordinates” indicates a position of object data with reference to a predetermined origin on the display of the device 2. The position of the object data is, for example, the position of the upper left apex of a circumscribed rectangle of the object data. The coordinates are expressed, for example, in pixels of the display 3. The item “size” indicates a width and a height of the circumscribed rectangle of the object data.

### Detection of Pointing Position Coordinates

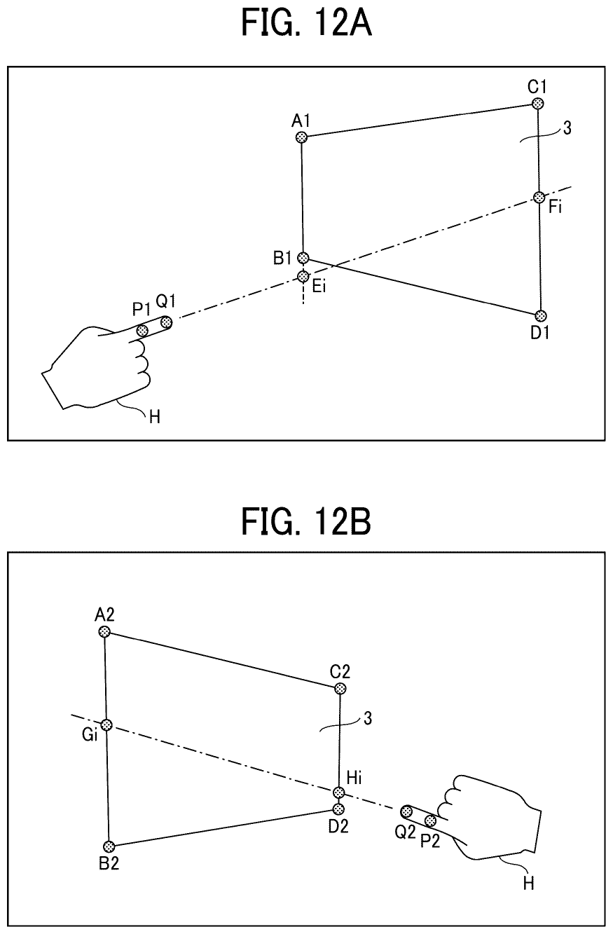

The detection of the pointing position coordinates of a position on the display 3 pointed to by the operator with the finger is described below with reference to FIG. 11. FIG. 11 is a diagram illustrating the arrangement of the finger photographing cameras. The finger photographing camera (right) 471 and the finger photographing camera (left) 472 are used for detecting the coordinates of the position on the display 3 pointed to by the operator with the finger. In FIG. 11, the finger photographing camera (left) 472 is arranged on a table and the finger photographing camera (right) 471 is arranged at the surrounding of the table. The finger photographing camera (right) 471 and the finger photographing camera (left) 472 only need to be arranged at locations from which the display 3 and the area beyond the wrist of the operator can be photographed. The finger photographing camera (right) 471 and the finger photographing camera (left) 472 may be cameras that can acquire distance information to a subject as well as an image. In this way, the gesture recognition unit 18 and the pointing position detection unit 16 can easily determine the state of the fingers, for example, how many fingers are involved.

At least two cameras need to be arranged as the finger photographing cameras (right) 471 and (left) 472, but three or more cameras may be arranged. The device 2 may use two pieces of image data from which a hand is easily recognized from among three or more pieces of image data. Alternatively, the device 2 may detect coordinates of the position pointed to by the operator with the finger using combinations of taking two pieces of image data out of all pieces of image data and use an average of the detected coordinates. The finger photographing camera (right) 471 or the finger photographing camera (left) 472 may be a spherical camera.

Subsequently, a process for displaying a pointer at a position on the display 3 pointed to by the operator with the finger is described below. In this process, the image data received from both finger photographing cameras (right and left) is also used.

In a pointer mode, a pen mode, a marker mode, or an eraser mode, when the gesture recognition unit 18 recognizes that the shape of the hand changes to the shape of the hand with one finger extended, the gesture recognition unit 18 transmits, to the pointing position detecting unit 16, a command to start an operation to detect the coordinates of the position on the display 3 pointed to by the operator with the finger. Using a model generated by machine learning in the similar manner as the gesture recognition unit 18, the pointing position detection unit 16 obtains an object such as a hand from the right photographed image and determines that the object is a hand with one finger extended.

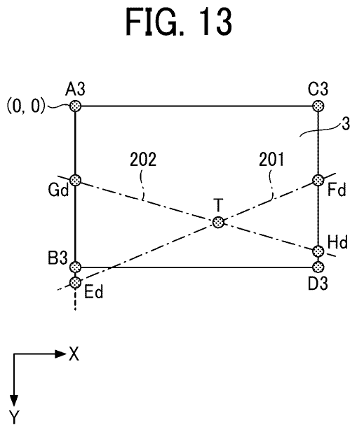

In response to receiving the command, the pointing position detection unit 16 starts an operation to detect the coordinates of the position on the display 3 pointed to by the operator with the finger using the image data received from the finger photographing camera (right) 471 and the finger photographing camera (left) 472 via the short-range communication circuit 419. FIG. 12A is a diagram illustrating an image (right photographed image) photographed by the finger photographing camera (right) 471. FIG. 12B is a diagram illustrating an image (left photographed image) photographed by the finger photographing camera (left) 472.

In FIG. 11, the device 2 includes the display 3, but the display 3 may be externally attached. In this case, the finger photographing camera (right) 471, the finger photographing camera (left) 472, and the distance image sensor 460 are arranged so as to be able to photograph or detect the operator, and these devices and component are connected to an information processing apparatus. The information processing apparatus and the display 3 externally attached are connected by wire or wireless.

Subsequently, the pointing position detection unit 16 identifies the base (a point P1 in FIG. 12A) and tip (a point Q1 in FIG. 12A) of the one finger based on the right photographed image. The pointing position detection unit 16 also compares the shape data of the object obtained from the right photographed image with the shape data of the display 3 of the device 2 stored in advance to determines that the object is the display 3 of the device 2. A model generated by machine learning may be used for this determination. In the photographed image in FIG. 12A, points A1, B1, C1, and D1 correspond to the upper left corner, the lower left corner, the upper right corner, and the lower right corner of the display 3 of the device 2, respectively. In the photographed image in FIG. 12A, a point Ei is the intersection point of the extension line of the line segment connecting the points P1 and Q1 and the extension line of the line segment connecting the points A1 and B1. Also, a point Fi is the intersection point of the extension line of the line segment connecting the points P1 and Q1 and the extension line of the line segment connecting the points C1 and D1.

Based on the left photographed image, the pointing position detection unit 16 determines that the object is the hand with the one finger extended in the similar manner as described above, and further identifies the base (a point P2 in FIG. 12B) and tip (a point Q2 in FIG. 12B) of this extended one finger. Subsequently, the pointing position detection unit 16 determines that the object is the display 3 of the device 2 based on the left photographed image. In the photographed image in FIG. 12B, points A2, B2, C2, and D2 correspond to the upper left corner, the lower left corner, the upper right corner, and the lower right corner of the display 3 of the device 2, respectively. In the photographed image in FIG. 12B, a point Gi is the intersection point of the extension line of the line segment connecting the points P2 and Q2 and the extension line of the line segment connecting the points A2 and B2. Also, a point Hi is the intersection point of the extension line of the line segment connecting the points P2 and Q2 and the extension line of the line segment connecting the points C2 and D2.

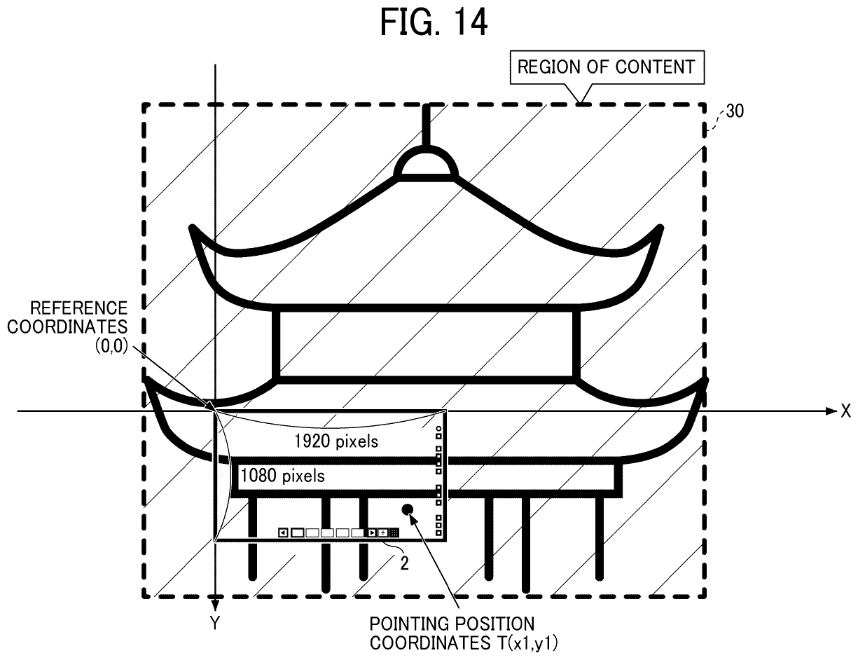

FIG. 13 is a front view of the display 3 of the device 2. Pointing position coordinates T of the position on the display 3 of the device 2 pointed to by the operator with the finger correspond to the intersection point of a line connecting the points Ei and Fi in the image photographed by the finger photographing camera (right) 471 and a line connecting the points Gi and Hi in the image photographed by the finger photographing camera (left) 472. Since the coordinates of the position in the image are based on the pixel position in the photographed image, in order to display a pointer at the position pointed to by the operator with the finger, the coordinates of the position in the image need to be converted into coordinates based on the pixel position of the display 3 of the device 2.

In FIG. 13, points A3, B3, C3, and D3 correspond to the upper left corner, the lower left corner, the upper right corner, and the lower right corner of the display 3 of the device 2, respectively. Points Ed and Fd are coordinate points based on the display pixel positions of the display 3 of the device 2. The points Ed and Fd are obtained by, using a coordinate conversion matrix TR described below, converting the coordinates based on the pixel positions of the photographed image of the points Ei and Fi in the image (i.e., the right photographed image) photographed by the finger photographing camera (right) 471. Points Gd and Hd are coordinate points based on the display pixel positions of the display 3 of the device 2. The points Gd and Hd are obtained by, using a coordinate conversion matrix TL described below, converting the coordinates based on the pixel positions of the photographed image of the points Gi and Hi in the image (i.e., the left photographed image) photographed by the finger photographing camera (left) 472.

The coordinate conversion matrices TR and TL are obtained by the following equations. It is assumed that the coordinates of the upper left corner of the display 3 based on the pixel position of the image (i.e., the right photographed image) photographed by the finger photographing camera (right) 471 are the point A1 (a1x, a1y). Similarly, it is assumed that the coordinates of the lower left corner, the upper right corner, and the lower right corner are the point B1 (b1x, b1y), the point C1 (c1x, c1y), and the point D1 (d1x, d1y), respectively. The coordinate conversion matrix TR represented by Equation (1) is obtained by eight simultaneous equations as follows:

$$a 3 x = ( R 11 \times a 1 x + R 12 \times a 1 y + R 13 ) / ( R 31 \times a 1 x + R 32 \times a 1 y + 1 ) ;$$

$$a 3 y = ( R 21 \times a 1 x + R 22 \times a 1 y + R 23 ) / ( R 31 \times a 1 x + R 32 \times a 1 y + 1 ) ;$$

$$b 3 x = ( R 11 \times b 1 x + R 12 \times b 1 y + R 13 ) / ( R 31 \times b 1 x + R 32 \times b 1 y + 1 ) ;$$

$$b 3 y = ( R 21 \times b 1 x + R 22 \times b 1 y + R 23 ) / ( R 31 \times b 1 x + R 32 \times b 1 y + 1 ) ;$$

$$c 3 x = ( R 11 \times c 1 x + R 12 \times c 1 y + R 13 ) / ( R 31 \times c 1 x + R 32 \times c 1 y + 1 ) ;$$

$$c 3 y = ( R 21 \times c 1 x + R 22 \times c 1 y + R 23 ) / ( R 31 \times c 1 x + R 32 \times c 1 y + 1 ) ;$$

$$d 3 x = ( R 11 \times d 1 x + R 12 \times d 1 y + R 13 ) / ( R 31 \times d 1 x + R 32 \times d 1 y + 1 ) ; and$$

$$d 3 y = ( R 21 \times d 1 x + R 22 \times d 1 y + R 23 ) / ( R 31 \times d 1 x + R 32 \times d 1 y + 1 )$$

$$TR = ( \begin{matrix}R 11 & R 12 & R 13 \\ R 21 & R 22 & R 23 \\ R 31 & R 32 & R 33\end{matrix} ) \qquad ( 1 )$$

It is assumed that the coordinates of the upper left corner of the display 3 based on the pixel position of the image (i.e., the left photographed image) photographed by the finger photographing camera (left) 472 are the point A2 (a2x, a2y). Similarly, it is assumed that the coordinates of the lower left corner, the upper right corner, and the lower right corner are the point B2 (b2x, b2y), the point C2 (c2x, c2y), and the point D2 (d2x, d2y), respectively. The coordinate conversion matrix TL represented by Equation (2) is obtained by eight simultaneous equations as follows:

$$a 3 x = ( L 11 \times a 2 x + L 12 \times a 2 y + L 13 ) / ( L 31 \times a 2 x + L 32 \times a 2 y + 1 ) ;$$

$$a 3 y = ( L 21 \times a 2 x + L 22 \times a 2 y + L 23 ) / ( L 31 \times a 2 x + L 32 \times a 2 y + 1 ) ;$$

$$b 3 x = ( L 11 \times b 2 x + L 12 \times b 2 y + L 13 ) / ( L 31 \times b 2 x + L 32 \times b 2 y + 1 ) ;$$

$$b 3 y = ( L 21 \times b 2 x + L 22 \times b 2 y + L 23 ) / ( L 31 \times b 2 x + L 32 \times b 2 y + 1 ) ;$$

$$c 3 x = ( L 11 \times c 2 x + L 12 \times c 2 y + L 13 ) / ( L 31 \times c 2 x + L 32 \times c 2 y + 1 ) ;$$

$$c 3 y = ( L 21 \times c 2 x + L 22 \times c 2 y + L 23 ) / ( L 31 \times c 2 x + L 32 \times c 2 y + 1 ) ;$$

$$d 3 x = ( L 11 \times d 2 x + L 12 \times d 2 y + L 13 ) / ( L 31 \times d 2 x + L 32 \times d 2 y + 1 ) ; and$$

$$d 3 y = ( L 21 \times d 2 x + L 22 \times d 2 y + L 23 ) / ( L 31 \times d 2 x + L 32 \times d 2 y + 1 )$$

$$TL = ( \begin{matrix}L 11 & L 12 & L 13 \\ L 21 & L 22 & L 23 \\ L 31 & L 32 & L 33\end{matrix} ) \qquad ( 2 )$$

The points Ei, Fi, Gi, and Hi in the photographed images are converted into the points Ed, Fd, Gd, and Hd represented by the display position coordinates of the display 3 of the device 2, using the coordinate conversion matrices. The coordinate conversion equations of these points are indicated by Equations (3) to (6). The point Ei (eix, eiy) is converted to the point Ed (edx, edy) by Equation (3).

$$( \begin{matrix}edtx \\ edty \\ edta\end{matrix} ) = ( \begin{matrix}R 11 & R 12 & R 13 \\ R 21 & R 22 & R 23 \\ R 31 & R 32 & R 33\end{matrix} ) ( \begin{matrix}eix \\ eiy \\ 1\end{matrix} ) \qquad ( 3 )$$

$$edx = edtx / edta$$

$$edy = edty / edta$$

The point Fi (fix, fiy) is converted to the point Fd (fdx, fdy) by Equation (4).

$$( \begin{matrix}fdtx \\ fdty \\ fdta\end{matrix} ) = ( \begin{matrix}R 11 & R 12 & R 13 \\ R 21 & R 22 & R 23 \\ R 31 & R 32 & R 33\end{matrix} ) ( \begin{matrix}fix \\ fiy \\ 1\end{matrix} ) \qquad ( 4 )$$

$$fdx = fdtx / fdta$$

$$fdy = fdty / fdta$$

The point Gi (gix, giy) is converted to the point Gd (gdx, gdy) by the Equation (5).

$$( \begin{matrix}gdtx \\ gdty \\ gdta\end{matrix} ) = ( \begin{matrix}L 11 & L 12 & L 13 \\ L 21 & L 22 & L 23 \\ L 31 & L 32 & L 33\end{matrix} ) ( \begin{matrix}gix \\ giy \\ 1\end{matrix} ) \qquad ( 5 )$$

$$gdx = gdtx / gdta$$

$$gdy = gdty / gdta$$

The point Hi (hix, hiy) is converted to the point Hd (hdx, hdy) by Equation (6).

$$( \begin{matrix}hdtx \\ hdty \\ hdta\end{matrix} ) = ( \begin{matrix}L 11 & L 12 & L 13 \\ L 21 & L 22 & L 23 \\ L 31 & L 32 & L 33\end{matrix} ) ( \begin{matrix}hix \\ hiy \\ 1\end{matrix} ) \qquad ( 6 )$$

$$hdx = hdtx / hdta$$

$$hdy = hdty / hdta$$

In FIG. 13, the pointing position coordinates T on the display 3 of the device 2 pointed to by the operator with the finger is the intersection point of the line segment connecting the points Ed and Fd and the line segment connecting the points Gd and Hd. Therefore, by obtaining a linear equation 201 of the line segment connecting the points Ed and Fd and a linear equation 202 of the line segment connecting the points Gd and Hd and using these two linear equations as simultaneous equations, the display coordinates of the pointing position coordinates T are obtained. In FIG. 13, the pointing position coordinates T are present within the display area of the display 3. However, depending on the inclinations of linear equations 201 and 202, the pointing position coordinates T present outside the display area of the display 3 are detected.

The coordinates of a pixel on the display 3 are expressed by orthogonal coordinates in which the pixel position at the upper left corner of the display area is set as the origin, and the rightward direction is set as the positive direction of an X-axis and the downward direction is set as the positive direction of a Y-axis. In other words, the display coordinates are expressed by the number of pixels in the X-axis direction from the origin and the number of pixels in the Y-axis direction from the origin.

The device 2 of the present embodiment detects the pointing position coordinates present outside the display area of the display 3. The device 2 virtually enlarges the plane of the display 3 and the pointing position coordinates present on this virtual plane are also expressed by the display coordinates. The pixels of the display 3 and the pixels of drawing data in the memory to be displayed on the display 3 have a one-to-one correspondence. In other words, the device 2 displays an image based on the drawing data in the memory as it is without thinning or interpolating the drawing data.

### Display Area Switching Process

Subsequently, the display control unit 13 switches the display area of the display of the device 2 so that the detected pointing position coordinates T are set at the center of the display 3. In the following description, the resolution (the width×the height) of the display 3 is set to “1920×1080” pixels, which is the full high-definition (HD) standard. Alternatively, the resolution may be, for example, “3840×2160 (so called 4K)” or “7680×4320 (so called 8K).”

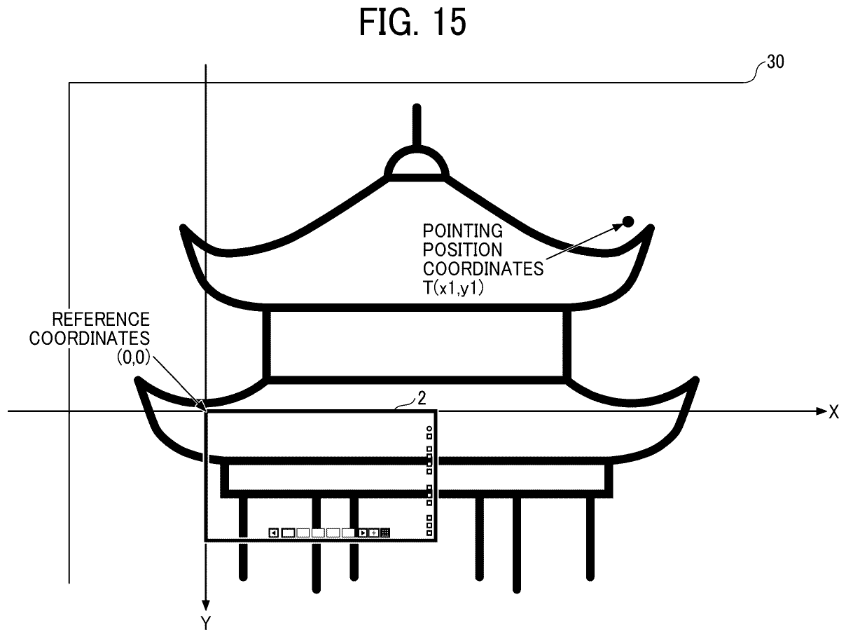

FIG. 14 is a diagram illustrating a region where pointing position coordinates are present for which the device 2 determines that the display area needs to be switched. The display area is switched only when the display 3 is displaying a content larger than the display area of the display 3. The display control unit 13 checks whether the pointing position coordinates T are outside the display area.

The display area is equal to the region of the content 30 displayed on the display 3. In a coordinate system in which the upper left corner of the device of the device 2 is defined as coordinates (0, 0), the region displayed on the display 3 is identified by two points of the coordinates of the upper left corner (0, 0) and the coordinates of the lower right corner (1920, 1080) of the display area displayed on the display 3. When the pointing position coordinates T are within the display area, the device 2 determines that the display area does not need to be switched.

When the pointing position coordinates T are outside the area of the display of the device 2, the display control unit 13 checks whether the pointing position coordinates T are within the region of the content 30. When the pointing position coordinates T (x1, y1) satisfy the following condition, the device 2 determines that the display area does not need to be switched.

$$0 \leq x 1 \leq 1920 and 0 \leq y 1 \leq 1080$$

Accordingly, in FIG. 14, when a position within the shaded region with oblique lines excluding the display area is pointed to by the operator with the finger, the device 2 determines that the display area needs to be switched and proceeds to the display area switching process.

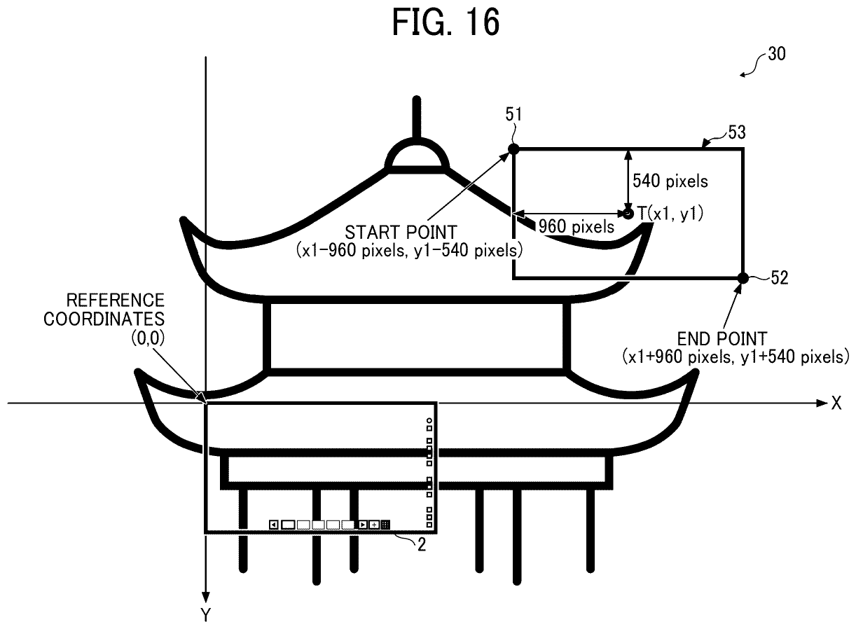

FIG. 15 is a diagram illustrating a case where the operator points with the finger to the position of the pointing position coordinates T (x1, y1) outside the display area. The display control unit 13 determines a region of the display area centered on the pointing position coordinates T in order to display the pointing position coordinates T at the center of the display of the device 2.

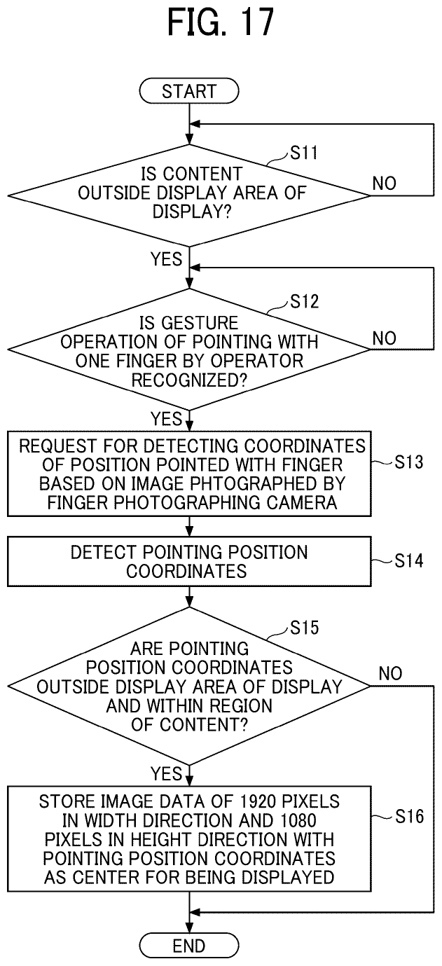

FIG. 16 is a diagram illustrating the display area switching process. Since the size of the display area is 1920 pixels in width and 1080 pixels in height, an upper left corner 51 of the display area centered on the pointing position coordinates T (x1, y1) corresponds to coordinates (x1−1920/2 pixels, y1−1080/2 pixels). A lower right corner 52 of the display area centered on the pointing position coordinates T corresponds to coordinates (x1+1920/2 pixels, y1+1080/2 pixels). As described above, the region of the display area is a rectangular region 53 identified by two points of the coordinates (x1−960 pixels, y1−540 pixels) of the upper left corner 51 and the coordinates (x1+960 pixels, y1+540 pixels) of the lower right corner 52.

The display control unit 13 copies the image data corresponding to the rectangular region 53 of the content 30 to the display memory area of the display 3 for performing the display area switching process. The display control unit 13 controls the display 3 to display an image based on the image data copied to the display memory area to perform the display area switching process.

In the present embodiment, the case is described, in which the finger photographing camera (right) 471 and the finger photographing camera (left) 472 are constantly in operation. However, the finger photographing camera (right) 471 and the finger photographing camera (left) 472 may photograph only while the object representing the palm of the hand is showing the shape of the hand with the one finger extended. For example, the gesture recognition unit 18 recognizes that the object representing the palm of the hand changes to the shape of the hand with the one finger extended, and transmits, to the pointing position detection unit 16, a command for starting to detect the position on the display 3 pointed to by the operator with the finger. In response to receiving the command for starting, the pointing position detection unit 16 may instruct the finger photographing camera (right) 471 and the finger photographing camera (left) 472 to start photographing.

### Operation or Process

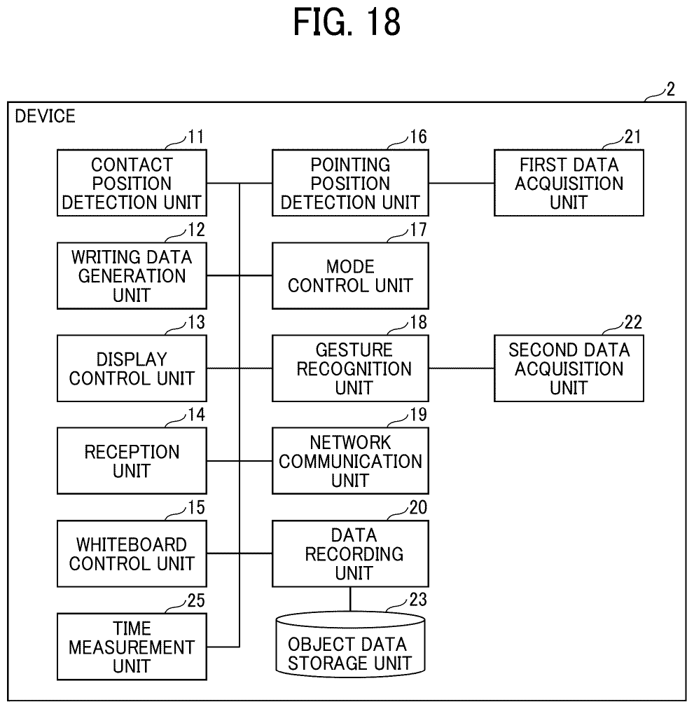

FIG. 17 is a flowchart of a process for displaying a region outside the display area in the display area in response to a gesture operation performed by the operator. At the start of the process in FIG. 17, the device 2 has already recognized the palm of the hand and is in the gesture recognition mode.

In step S11, the device 2 determines whether any part of the content 30 is outside the display area of the display 3. In the case where the result of the determination in step S11 is Yes (YES in step S11), the process proceeds to step S12. In the case where the result of the determination in step S11 is No (NO in step S11), the process of step S11 is repeated.

In step S12, the gesture recognition unit 18 analyzes the distance image data received from the distance image sensor 460 and determines whether a gesture operation of pointing with one finger is recognized. In the case where the result of the determination in step S12 is Yes (YES in step S12), the process proceeds to step S13. In the case where the result of the determination in step S12 is No (NO in step S12), the process of step S12 is repeated.

In step S13, the gesture recognition unit 18 requests the pointing position detection unit 16 to detect the pointing position coordinates of the position pointed to by the one finger.

In step S14, in response to the request, the pointing position detection unit 16 analyzes the pieces of image data acquired by the first data acquisition unit 21 from the finger photographing camera (right) 471 and the finger photographing camera (left) 472, respectively, and detects the pointing position coordinates of the position pointed to by the one finger.

In step S15, the pointing position detection unit 16 determines whether the pointing position coordinates are outside the area of the display and within the region of the content 30. In the case where the result of the determination in step S15 is Yes (YES in step S15), the process proceeds to step S16. In the case where the result of the determination in step S15 is No (NO in step S15), the process in FIG. 17 ends.

In step S16, the display control unit 13 acquires image data corresponding to a rectangular region of 1920 pixels in the width direction and 1080 pixels in the height direction with the pointing position coordinates as the center in the region of the content 30, and copies the image data to the display memory area. In step S16, the display control unit 13 further controls the display 3 to display an image based on the image data stored in the display memory area. In this way, the region of the content displayed in the display area of the display 3 is switched.

In the display area switching process, the device 2 may reduce the content 30 by a predetermined magnification when displaying a part of the content 30 centered on the pointing position coordinates. Since the pointing position coordinates are not necessarily accurate, a wide region can be displayed on the display 3 by reducing the content. Thus, the part of the content 30 desired by the operator is easily displayed. In the case where the content 30 is difficult to be seen because of the reduction, the content 30 may be enlarged in response to another gesture operation performed by the operator.

The technique in the art has an issue that the workload of the operator to operate the apparatus to display the content outside the area of the display device is large. For example, when discussing a region outside the region displayed on the display device, the operator needs to perform either an operation to reduce the content once and enlarge a desired region again or another operation to display the desired region by swiping without reducing the display. The former method requires the user to perform the operation for reduction, whereas the latter method requires the user to swipe repeatedly when the content that is far from the display area is desired to be displayed. When performing the operation of swiping, the user needs to touch the touch panel, and each time, the user has to go in front of the display device to operate the touch panel. Consequently, the efficiency of the conference decreases.

The device 2 according to the present embodiment, in order to display the details of the region not displayed by the display 3, does not need to reduce the size of the content 30 once so that the entirety of the content 30 is displayed or move the display area with continuous swiping in any direction. In addition, the operator can operate the display 2 to display a desired display area on the display 3 while being away from the device 2.

### Second Embodiment

In the present embodiment, a case is described, in which when a display area is switched in response to an operation performed by the operator pointing with one finger, the device 2 restricts the display area switching process instructed by another operator for a certain period of time. By restricting the display area switching process, the content 30 displayed on the display 3 is prevented from being switched one after another in response to operations performed by multiple operators randomly pointing to positions on the display area.

For example, for a certain period of time after the display control unit 13 controls the display 3 to display a part of a region where one or multiple contents are present at a position whose coordinates detected by the pointing position detection unit 16, the display control unit 13 does not change the region displayed on the display 3 even when the pointing position detection unit 16 detects coordinates of a position which is pointed to by a gesture operation and is outside the area of the display 3 and within the region where the one or multiple contents are present. Alternatively, the pointing position detection unit 16 may be restricted from detecting coordinates for a certain period of time.

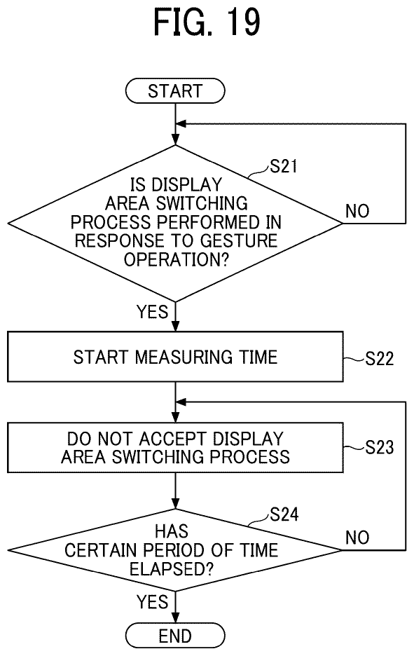

FIG. 18 is a block diagram illustrating a functional configuration of the device 2. The differences from FIG. 9 are described below with reference to FIG. 18. The device 2 of the present embodiment includes a time measurement unit 25. The time measurement unit 25 measures a certain period of time (e.g., 5 seconds) when the display area switching process is performed in response to a gesture operation, and notifies the display control unit 13 of the elapse of a certain period of time. The other functions are substantially the same as those in FIG. 9. Even if some functions are different from those in FIG. 9, the differences do not affect the description of the present embodiment. It is preferable that a certain period of time can be set by the operator.

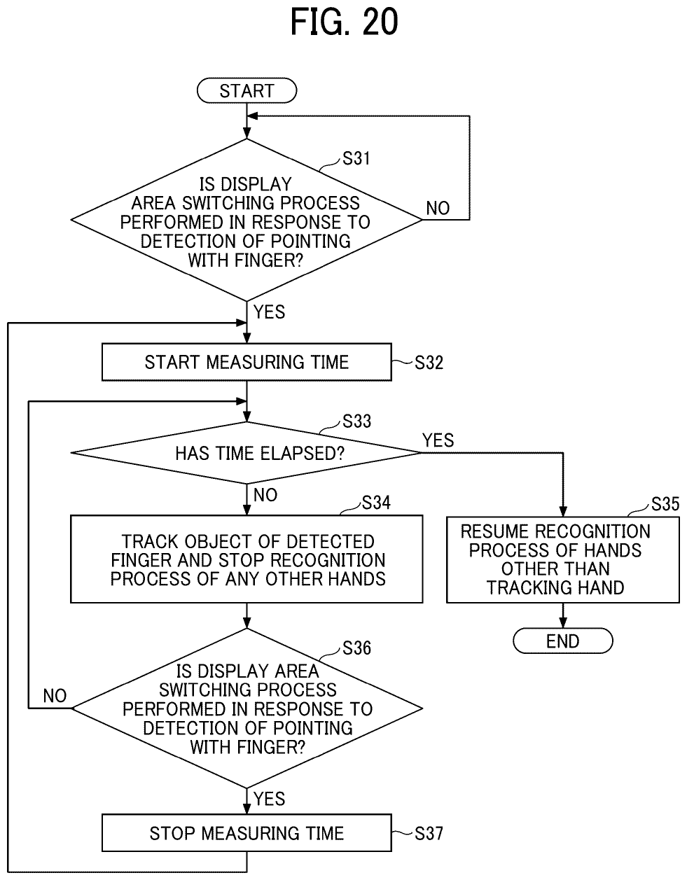

FIG. 19 is a flowchart of a process for restricting the display area switching process for a certain period of time.

In step S21, the device 2 determines whether the display area switching process has been performed in response to a gesture operation. In the case where the result of the determination in step S21 is Yes (YES in step S21), the process proceeds to step S22. In the case where the result of the determination in step S21 is No (NO in step S21), the process of step S21 is repeated.

When the display area switching process is performed in response to a gesture operation, in step S22, the time measurement unit 25 starts measuring a certain period of time.

Even when the determination in step S15 of FIG. 17 is Yes, in step S23, the display control unit 13 does not accept the display area switching process for a certain period of time. In other words, the display control unit 13 fixes the display area displayed on the display 3 until the display control unit 13 receives a notification from the time measurement unit 25. Note that the pointing position detection unit 16 can detect the coordinates of a position pointed to by one finger even before a certain period of time elapses. In this way, for example, a pointer can be displayed in response to a gesture operation.

In step S24, the display control unit 13 determines whether a certain period of time has elapsed. In the case where the result of the determination in step S24 is Yes (YES in step S24), the process in FIG. 19 ends. In the case where the result of the determination in step S24 is No (NO in step S24), the process returns to step S23.

The device 2 of the present embodiment can restrict the display area switching process instructed by another operator for a certain period of time in addition to providing the effects of the first embodiment.

### Third Embodiment

In the present embodiment, a case is described, in which the device 2 tracks the finger of a person who points to with one finger, and allows the display area switching process even within a certain period of time in the case where a gesture operation is performed by the same person. In this way, the display area is switched one after another when the instructions are given by the same operator. Thus, the operability is increased.

For example, even within a certain period of time after the display control unit 13 controls the display 3 to display a part of the content at a position whose coordinates detected by the pointing position detection unit 16, the pointing position detection unit 16 continues to detect coordinates of a position which is pointed to by a gesture operation performed by the same operator with the hand and is outside the area of the display 3 and within the region where the one or multiple contents are present. In this case, the display control unit 13 controls the display 3 to display the part of the content at the position whose coordinates detected by the pointing position detection unit 16.

The present embodiment is described on the assumption that the functional configuration illustrated in FIG. 18 is applicable. The pointing position detection unit 16 of the present embodiment obtains a hand object from pieces of image data captured by the finger photographing camera (right) 471 and the finger photographing camera (left) 472, respectively, and stores a feature amount of the hand object when a display area is switched. The feature amount may be, for example, information on the shape or color (represented by a histogram) of the hand object or a scale-invariant feature transform (SIFT) amount of the hand object. The pointing position detection unit 16 tracks the same finger based on the stored feature amount such as the information on the shape and the color of the hand object representing the hand with the one finger extended. As a technique for tracking the same object, for example, an optical flow may be used. In other words, the pointing position detection unit 16 tracks the hand object representing the hand of the same person with one finger extended.

When the hand object moves out of the angle of view of the finger photographing camera (right) 471 and the finger photographing camera (left) 472, the pointing position detection unit 16 again compares the feature amount of a hand object when the hand object enters the angle of view with the stored feature amount of the hand object. Then, the pointing position detection unit 16 determines whether the hand object entered the angle of view is the hand object representing the hand of the operator who has last instructed the display area switching process. In this case, the region where the hand object is detected may be limited to a predetermined region centered on the position pointed to by the finger before the hand object moves out of the angle of view.

While the hand object of the operator who has instructed the display area switching process is detected, the display control unit 13 stops the display area switching process instructed by another operator. When a certain period of time elapses, the pointing position detection unit 16 discards the feature amount of the hand object representing the hand of the person who has instructed the display area switching process, and resumes the display area switching process instructed by another operator.

Note that even within a certain period of time, the detection of pointing position coordinates of a position pointed to by another operator with one finger is allowed. In this way, the other operator can make a discussion by pointing to a position on the display area with a pointer.

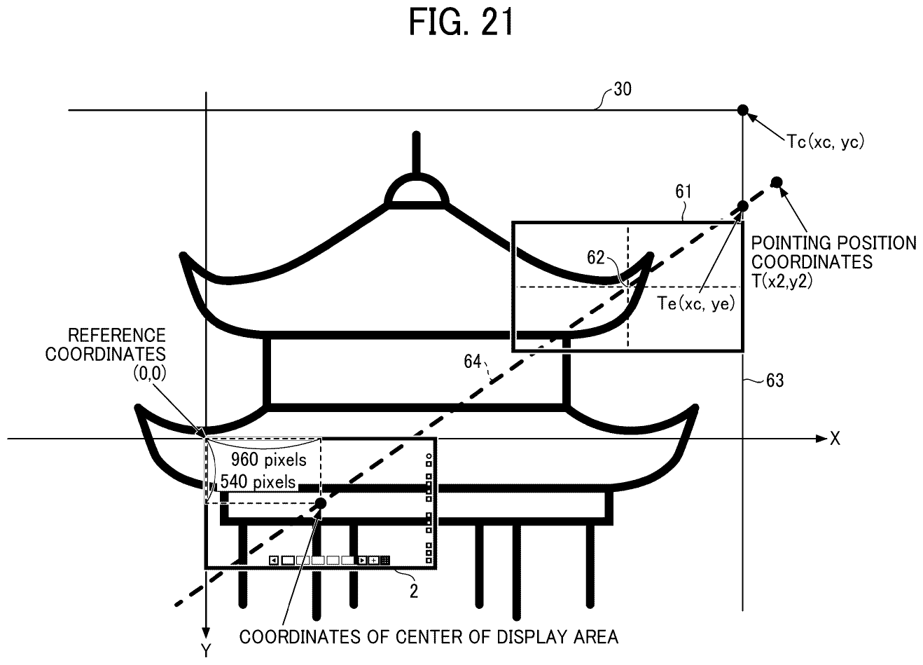

FIG. 20 is a flowchart of a process for allowing the display area switching process instructed by the same operator even within a certain period of time.

In step S31, the device 2 determines whether the display area switching process has been performed in response to detection of pointing with a finger. In the case where the result of the determination in step S31 is Yes (YES in step S31), the process proceeds to step S32. In the case where the result of the determination in step S31 is No (NO in step S31), the process of step S31 is repeated.

In step S32, the time measurement unit 25 starts measuring a certain period of time.

In step S33, the pointing position detection unit 16 determines whether a certain period of time has elapsed. In the case where the result of the determination in step S33 is Yes (YES in step S33), the process proceeds to step S35. In the case where the result of the determination in step S33 is No (NO in step S33), the process proceeds to step S34.

In step S34, the pointing position detection unit 16 tracks the hand object representing the hand of the operator who has last instructed the display area switching process, and does not accept the display area switching process instructed by any other operators.

In step S35, the gesture recognition unit 18 resumes the display area switching process instructed by another operator other than the operator who has instructed the display area switching process. The process for detecting the pointing with a finger is performed at predetermined time intervals (e.g., every second).

According to the present embodiment, in addition to the effect of the second embodiment, the display area switching process instructed by another operator is restricted for a certain period of time, and the display area is switched one after another when the instructions are given by the same operator. Thus, the operability is increased.

### Fourth Embodiment

In the present embodiment, a case is described, in which when the coordinates of a position pointed to by one finger on the display 3 are coordinates that are significantly outside the region where the one or multiple contents are present, the device 2 sets a region at the edge in the region where the one or multiple contents are present in the direction of the coordinates of the position pointed to by the one finger as the display area.

For example, when the pointing position detection unit 16 detects coordinates of a position which is pointed to by the finger of the operator performing a gesture operation and is outside the area of the display 3 and outside the region where the one or multiple contents reside, the display control unit 13 controls the display 3 to display a region that is centered on a line connecting the origin of the display 3 and the detected coordinates and located at the edge of the region where the one or multiple contents are present.

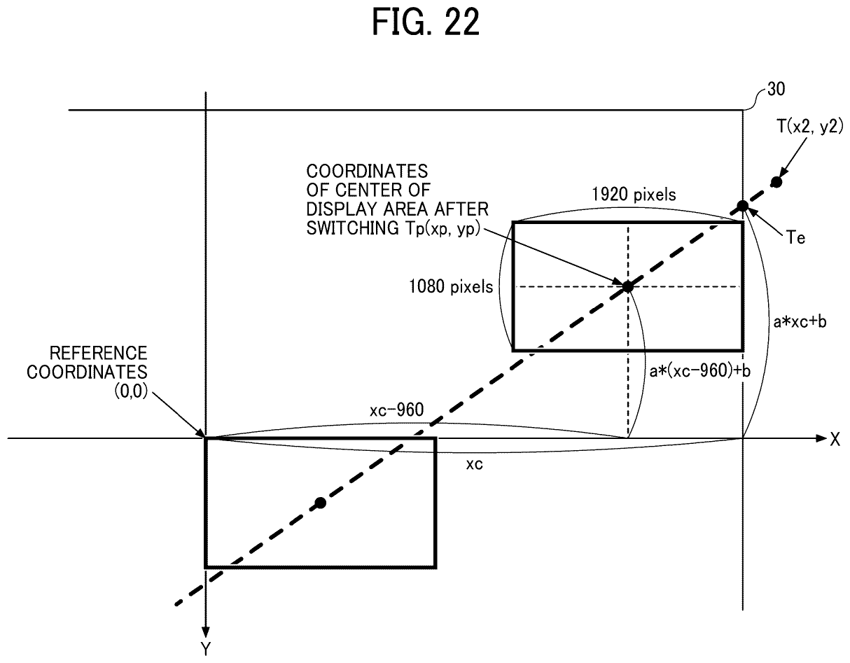

FIG. 21 is a diagram illustrating an edge region 61 in the region of the content 30 in a direction of coordinates of a position pointed to by one finger on the display 3. The processes until the device 2 detects the pointing position coordinates T of the position pointed to by one finger on the display 3 are substantially the same as those of the first embodiment. Subsequently, the device 2 determines whether the display area needs to be switched. In the present embodiment, it is assumed that the pointing position coordinates T are outside the area of the display 3 and outside the region of the content 30. In this case, in the first embodiment, the device 2 determines that the display area does not need to be switched and ends the process. In the present embodiment, the edge region 61 in the direction of the pointing position coordinates T with respect to the origin is displayed.

Position coordinate Tc of the pixel at the upper right corner of the region of the content 30 is represented by coordinates (xc, yc). A center 62 of the display area after being switched is on a line 64. The pointing position detection unit 16 detects the edge region 61 that satisfies a condition that the center 62 of the display area after being switched is on the line 64 connecting the coordinates (960, 540) of the center of the display area of the display of the device 2 and the pointing position coordinates T and that one of the four sides of the display area after being switched aligns with an outer frame 63 of the region of the content 30.

The intersection point between the line 64 connecting the coordinates (960, 540) of the center of the display area of the display of the device 2 and the pointing position coordinates T and the outer frame 63 corresponding to the edge of the region of the content 30 is represented by coordinates Te (xc, ye). The line 64 is expressed by a linear function with “a” as the slope and “b” as the intercept. In the calculation for detecting the coordinates of the center of the display area after being switched using this linear function, it is defined that, with respect to the reference coordinates (the coordinates of the position at the upper left corner of the display area of the display of the device 2), the right direction of the X axis is the positive direction of the X coordinate, the left direction of the X axis is the negative direction of the X coordinate, the upward direction of the Y axis is the positive direction of the Y coordinate, and the downward direction of the Y axis is the negative direction of the Y coordinate. By substituting the pointing position coordinates T (x2, y2) into this linear function, the following Equation (7) is derived.

$$y 2 = a \times 2 + b \qquad ( 7 )$$

By substituting the coordinates (960, 540) of the center of the display area of the display of the device 2 into this linear function, the following Equation (8) is derived.

$$- 540 = a \times 960 + b \qquad ( 8 )$$

Based on Equations (7) and (8), “a” as the slope and “b” as the intercept are expressed by the following Equations.

$$a = ( - 540 - y 2 ) / ( 960 - x 2 ) \qquad ( 9 )$$

$$b = y 2 - ( ( - 540 - y 2 ) / ( 960 - x 2 ) ) \times 2 \qquad ( 10 )$$

Since the intersection point of the coordinates Te is also a point on the line of the linear function described above, the following Equation (11) is derived using Equations (9) and (10).

$$ye = a \times xc + b \qquad ( 11 )$$

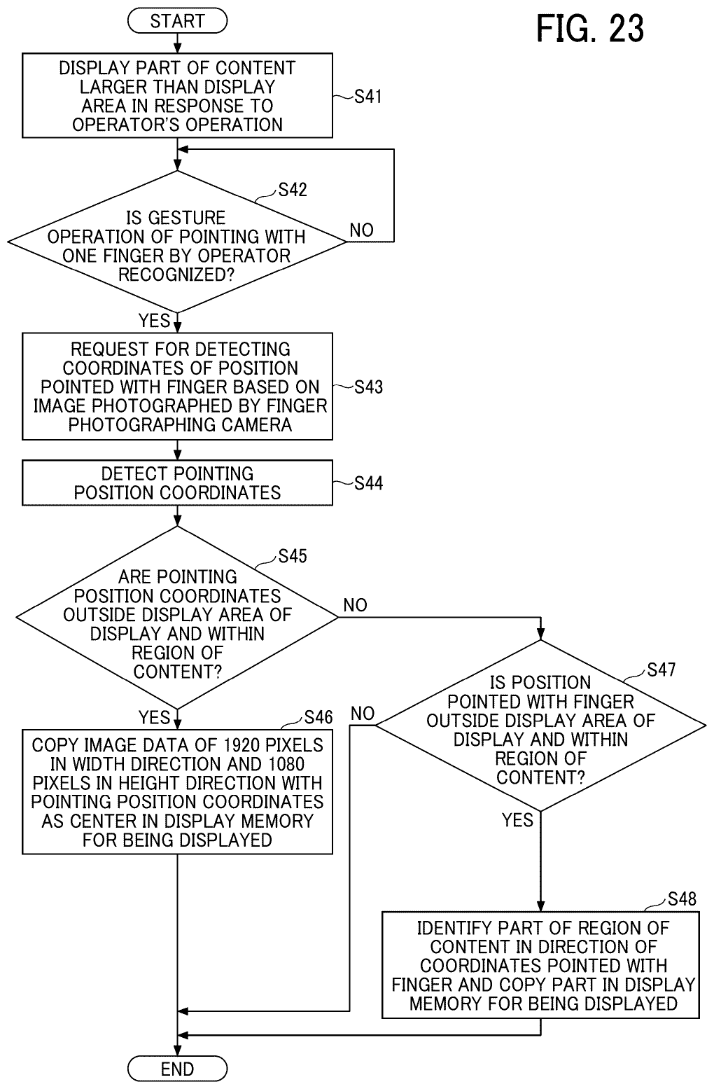

FIG. 22 is a diagram illustrating center coordinates Tp (xp, yp) of the display area after being switched. The x coordinate of the center coordinates Tp is represented by “xc−960” based on the coordinates (Te) of the intersection point. By substituting the x coordinate into the linear function described above, the y coordinate yp′ of the center coordinate Tp is represented by the following Equation (12).

$$y {p}^{′} = a \times ( xc - 960 ) + b \qquad ( 12 )$$

Since this value yp′ is a value based on the assumption that the upward direction on the Y axis is defined as the positive direction, the y coordinate yp in the display coordinates of the display 3 is detected by the following Equation (13).

$$yp = - a \times ( xc - 960 ) - b \qquad ( 13 )$$

The value “a” is obtained by Equation (9) and the value “b” is obtained by Equation (10).

As described above, the center coordinates Tp (xc−960, −a×(xc−960)−b) of the edge region 61 are detected. The value “a” is obtained by Equation (9) and the value “b” is obtained by Equation (10). From this point of time, the display area switching process to switch to the display area centered on the center coordinates Tp can be performed in the same manner as in the first embodiment.

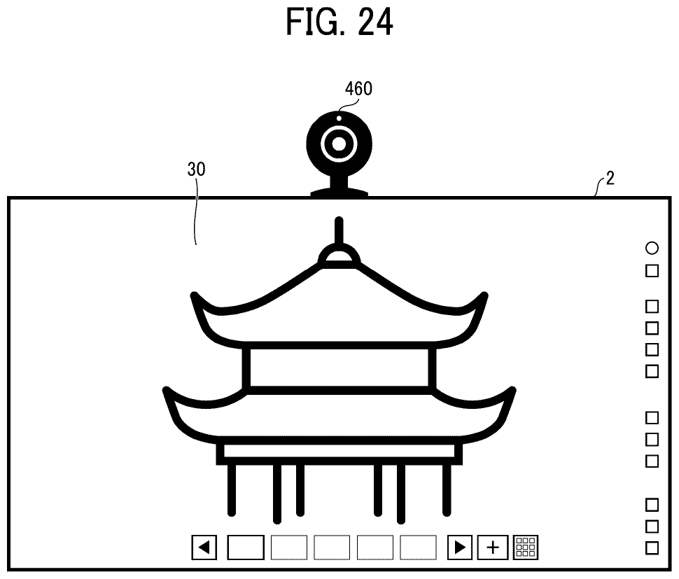

FIG. 23 is a flowchart of a process for displaying a region outside a display area in the display area in response to a gesture operation performed by the operator. The differences from FIG. 17 are described below with reference to FIG. 23. The processes of steps S41 to S46 illustrated in FIG. 23 are substantially the same as the processes of steps S11 to S16 illustrated in FIG. 17. In the case where the result of the determination in step S45 is No (NO in step S45), in step S47, the pointing position detection unit 16 determines whether the pointing position coordinates are outside the area of the display 3 and outside the region of the content 30. In the case where the result of the determination in step S47 is Yes (YES in step S47), the process proceeds to step S48. In the case where the result of the determination in step S47 is No (NO in step S47), the process in FIG. 23 ends.

In step S48, the display control unit 13 identifies the edge region 61 of the region of the content 30 in the direction connecting the origin and the pointing position coordinates T, and copies image data corresponding to the edge region 61 to the display memory area to display the edge region 61.

In the present embodiment, the edge region 61 is displayed on the display 3 even when the operator points to the outside of the region of the content 30. However, when the pointing position coordinates are far from the outer edge of the region of the content 30 by a predetermined distance or more, the pointing position coordinates may be ignored. For example, when the operator points to another operator unrelated to the content 30, the display area switching process is prevented from being performed.

According to the present embodiment, in addition to the effect of the first embodiment, even when the pointing position coordinates of the position pointed to by the operator with one finger are outside the region of the content 30, the edge region 61 of the region of the content 30 in the direction of the coordinates of the position pointed to by the operator is displayed. Since the operator cannot see the outside of the display area, the workload of the operator when instructing the edge region of the region of the content subjected to display to be displayed is reduced.

### Fifth Embodiment

In the first embodiment, an image larger than the area of the display 3 in size is displayed based on image data. In the present embodiment, any image in size contained in image data is used. The present embodiment is described on the assumption that the overall configuration illustrated in FIG. 7, the hardware configuration illustrated in FIG. 8, and the functional configuration illustrated in FIG. 9 are applicable.

As in the first embodiment, the present embodiment is described based on the assumption that image data of an architectural drawing displayed by the device 2 is acquired and discussion is conducted in a conference using the image data. For the sake of description, an image smaller than the area of the display 3 in size is displayed based on the image data in the present embodiment.

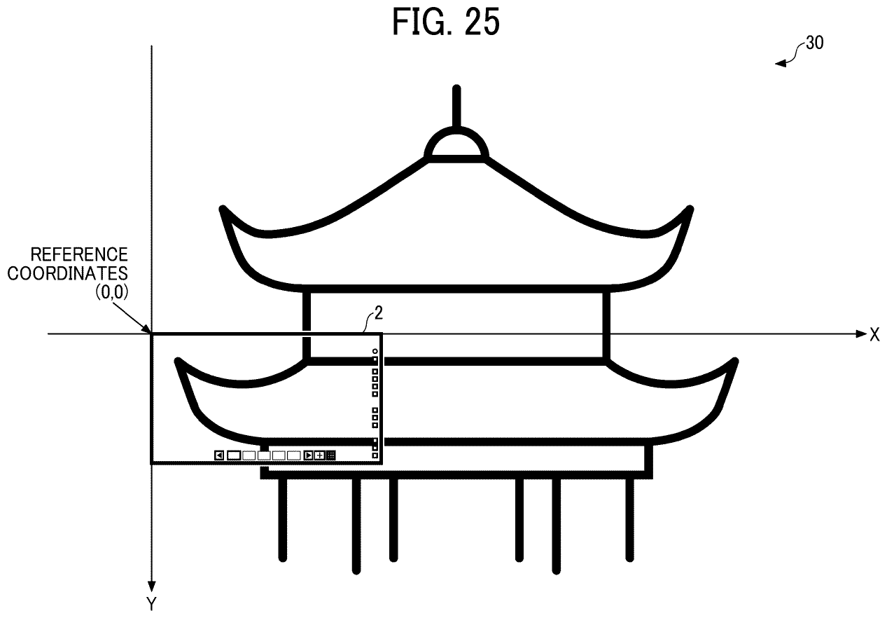

FIG. 24 is a diagram illustrating a case where the device 2 acquires image data of an architectural drawing as the content 30 used for discussion. In order to discuss a part of the content 30 displayed by the device 2 in detail, the operator performs a display operation so that the content 30 is enlarged and a desired region is displayed.

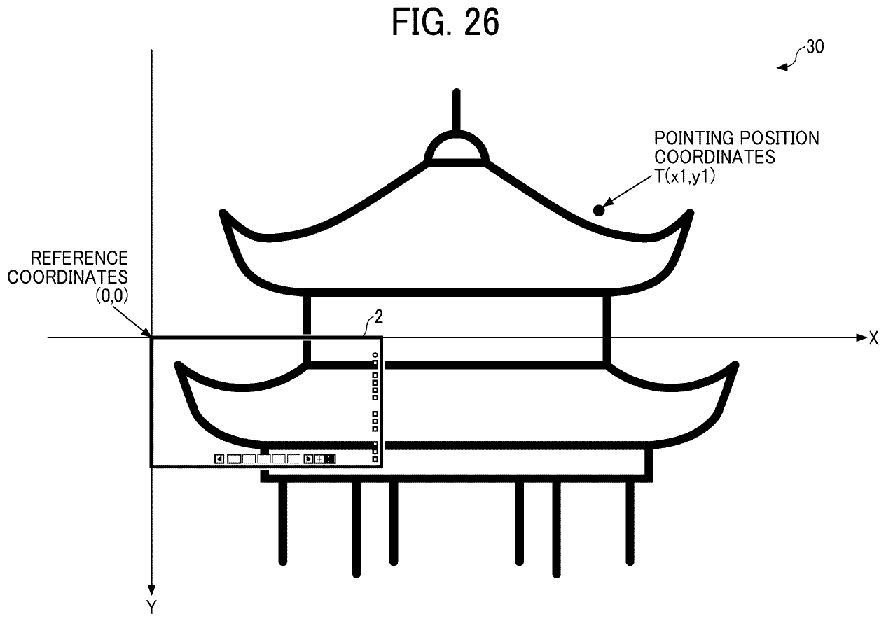

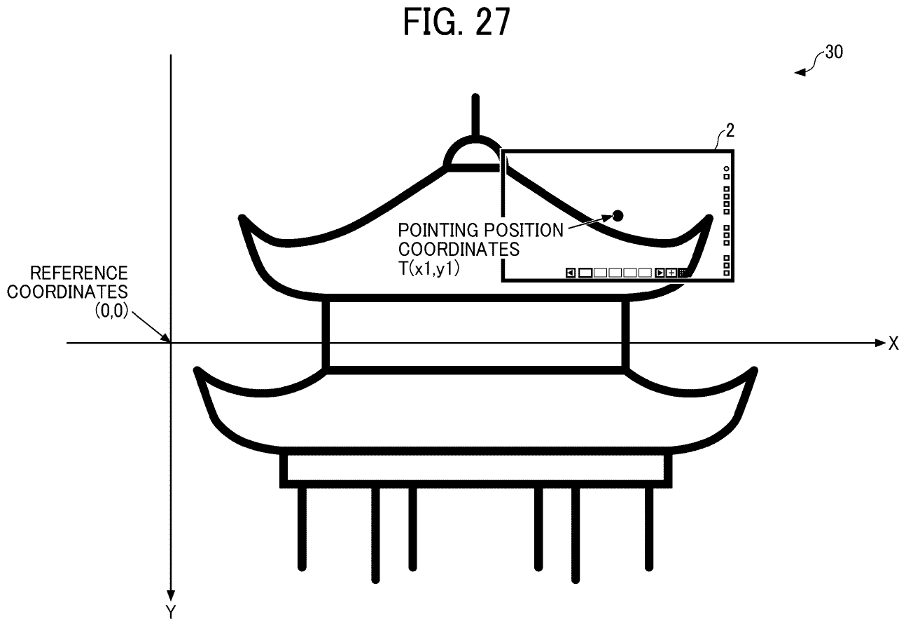

FIG. 25 is a diagram illustrating the content 30 displayed by the device 2 after the operator performs the display operation for enlargement. The operator desires to use the content 30 in the state illustrated in FIG. 24 and enlarge the content 30 in the state as illustrated in FIG. 25 to proceed with a discussion. When the discussion is over, the operator desires to move on to another discussion of another part of the content 30. In order to display the other part of the content 30 from the state illustrated in FIG. 25, a gesture operation with one finger is performed as in the first embodiment. When the operator points near the center of the region desired to be displayed, the finger photographing camera (right) 471 and the finger photographing camera (left) 472 photograph the operator. Then, the pointing position detection unit 16 detects the pointing position coordinates T of the position pointed to by the one finger. FIG. 26 is a diagram illustrating the pointing position coordinates T.

When the pointing position coordinates T are detected, the device 2 performs the display area switching process to switch the display area to the periphery of the pointing position coordinates T as in the first embodiment.

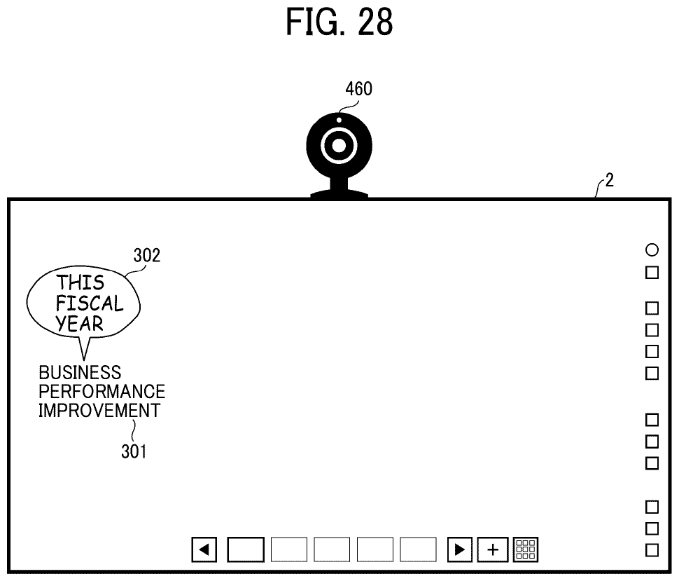

FIG. 27 is a diagram illustrating a case where the device 2 displays a part of the content 30 together with the entirety of the content 30 after the display area switching process is performed. The device 2 aligns the center of the display 3 with the pointing position coordinates T to display the content 30.

A case is described below, in which an image is displayed based on handwritten data that is larger than the capacity of the memory area corresponding to the display area with a swipe operation. The device 2 of the present embodiment has a writable region 48 that finitely extends beyond the area of the display 3. The display area displayed by device 2 can be moved by a swipe operation. The present embodiment is described based on the assumption that the operator proceeds with discussion in a conference using, for example, a stamp, text, or handwritten data input in various places in the writable region 48 of the device 2 as the content 30.

The operator (referred to as an operator A in the following description), who is the organizer of the conference, convenes several persons in a conference room and starts a conference about business performance improvement. The operator A uses a mind map on which issues and so on for the topic of the business performance improvement are written down radially so that new ideas come up, and proceeds with the conference. The operator A has used a text input function to display a software keyboard and input text data indicating the “business performance improvement” in the display area that is blank using the keyboard.

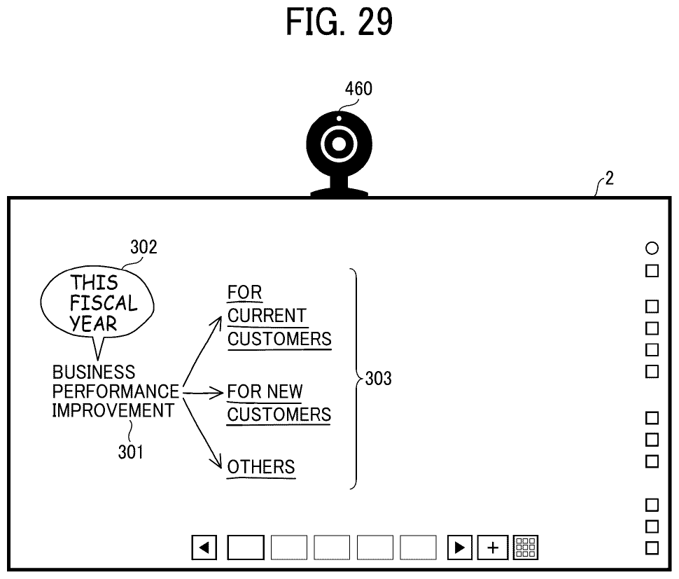

FIG. 28 is a diagram illustrating text data 301 input to the device 2. The operator A inputs handwritten data 302 that supplements the text data 301. In FIG. 28, the handwritten data 302 indicating “this fiscal year” is displayed. The participants in the conference discuss what approaches can be taken to the topic of the “business performance improvement” and write measures of each own in the display area of the device 2.

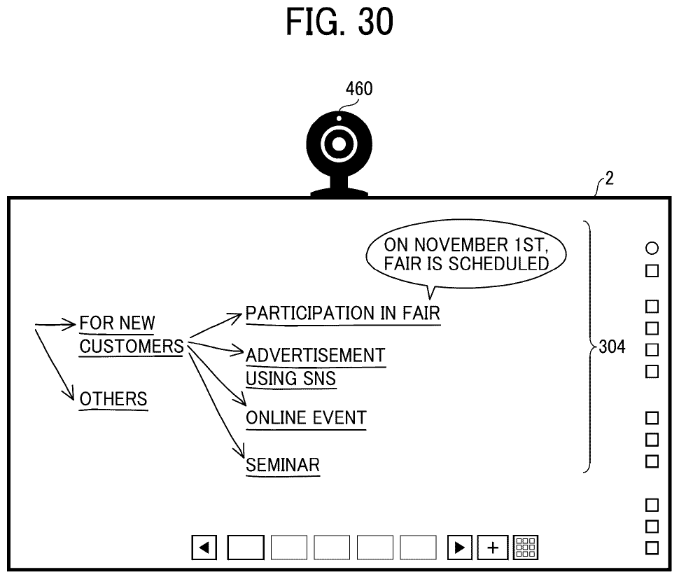

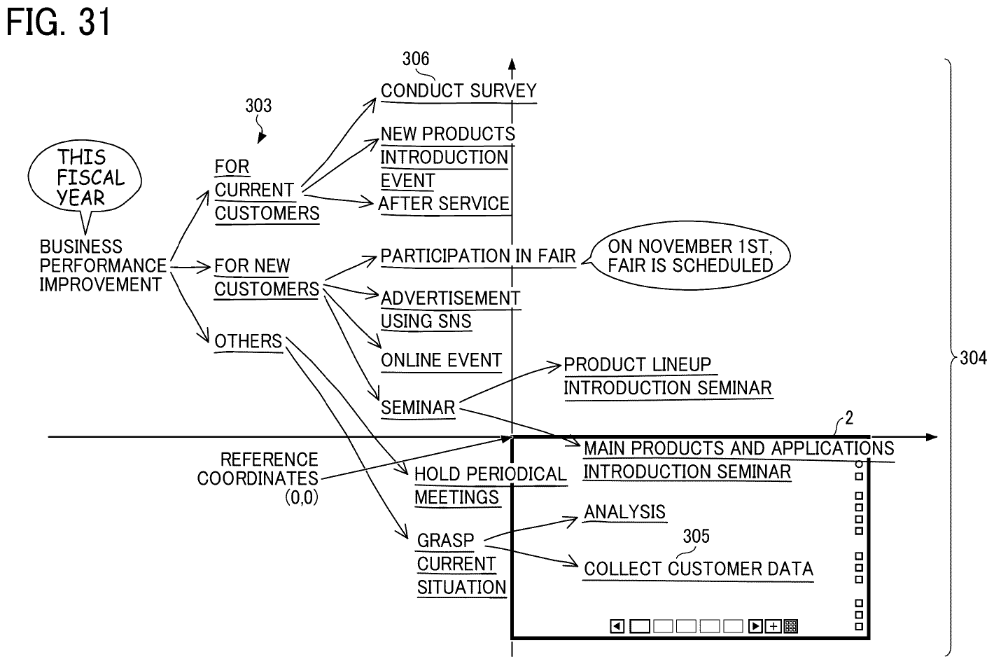

FIG. 29 is a diagram illustrating measures 303 input by the participants. The operator A solicits ideas related to the measures 303 input to the device 2. FIG. 30 is a diagram illustrating a case where the participants in the conference add ideas 304 radially to each of the measures 303 already displayed by the device 2. The ideas 304 includes, for example, a new keyword and a new topic.

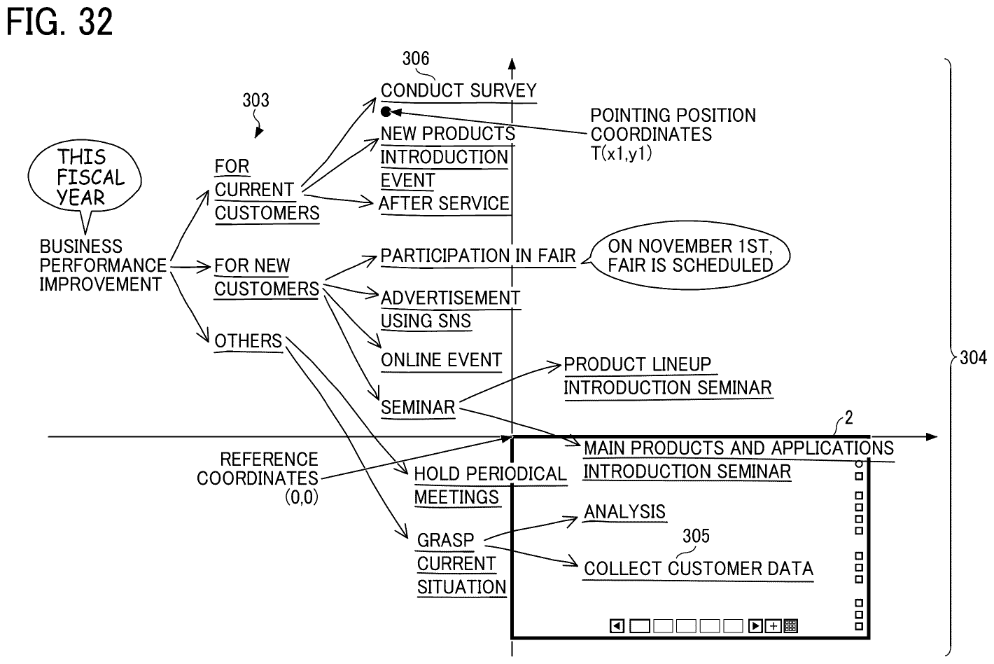

When a certain number of ideas 304 are input, some of the ideas may not fit within the display area of the device 2. In this case, as illustrated in FIG. 31, the operator A performs a swipe operation for the device 2 so that the display area is moved and writings can be added. As the operator A and the participants create a mind map by moving the display area, a large diagram that does not fit within the display area of the device 2 is created.

FIG. 31 is a diagram illustrating a relationship between an overall view of the mind map and the display area of the device 2. The operator A and the participants in the conference discuss the relationship among the keywords on the mind map and then move on to another discussion to make a proposal. The operator A thinks that there is a relationship between “collect customer data” 305 and “conduct survey” 306 on the mind map. However, as illustrated in FIG. 31, only the “collect customer data” 305 is displayed in the display area, and the presence of the “conduct survey” 306 cannot be indicated. The operator A who desires to inform the participants in the conference of the presence of the keyword “conduct survey” 306 points with one finger to the region where the keyword “conduct survey” 306 is supposed to be written.

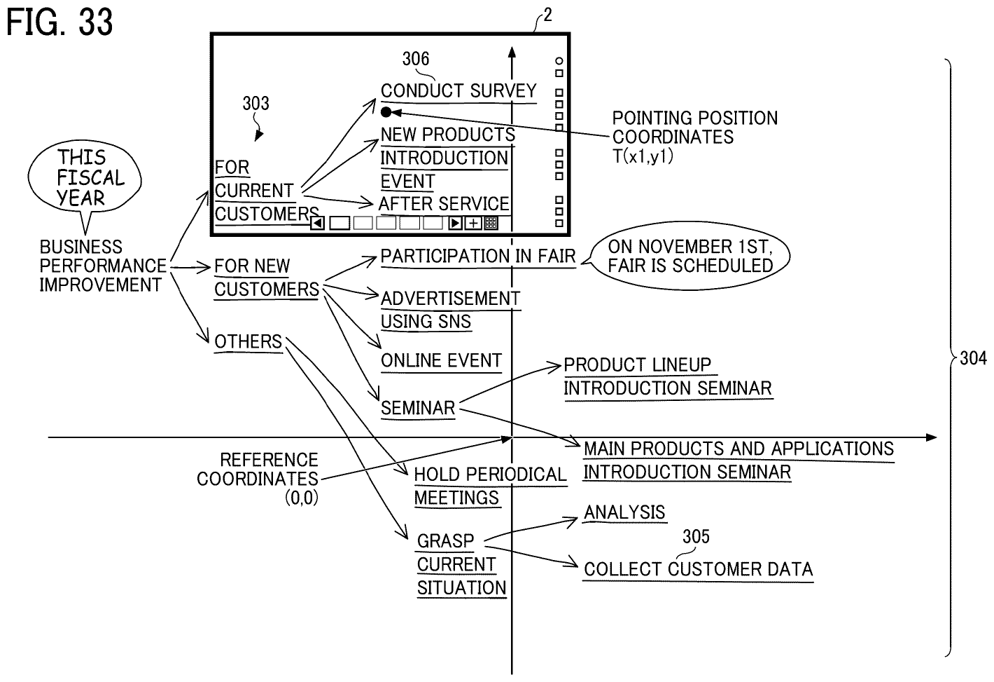

FIG. 32 is a diagram illustrating the pointing position coordinates T detected on the overall view of the mind map. When the pointing position coordinates T are detected, the device 2 performs the display area switching process to switch the display area to the periphery of the pointing position coordinates T as in the first embodiment.

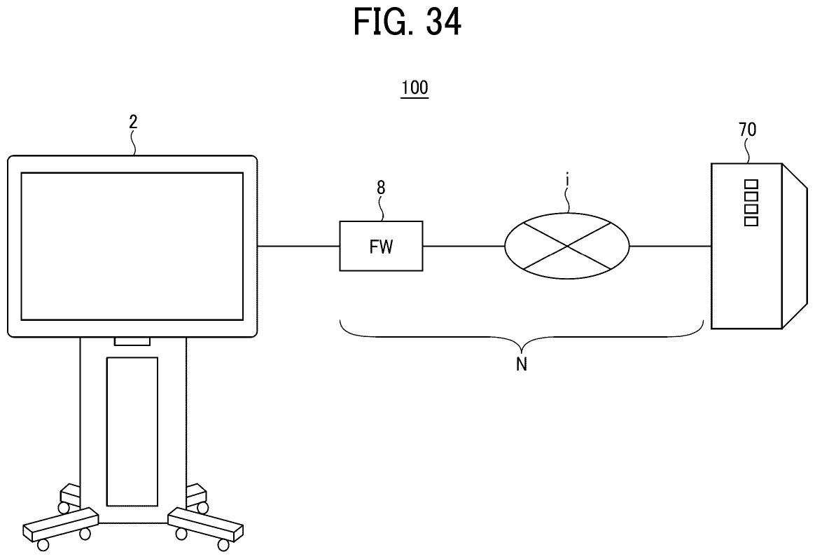

FIG. 33 is a diagram illustrating a display example after the display area switching process is performed. In FIG. 33, the “conduct survey” 306 is displayed in the display area of the device 2 after the display area switching process is performed. The device 2 aligns the center of the display 3 with the pointing position coordinates T to display the “conduct survey” 306 in the display area. In this way, the content 30 not displayed in the display area of the device 2 is displayed in response to the gesture operation performed by the operator A, and can be used for exchanging opinions.

### Sixth Embodiment

In the present embodiment, a display system is described in which an information processing apparatus on a network detects pointing position coordinates and the device 2 performs the display area switching process.

In the description of the present embodiment, like reference signs are given to elements operate similarly and provide the same or similar effects in the first embodiment, and redundant descriptions may be omitted or only the differences may be described.

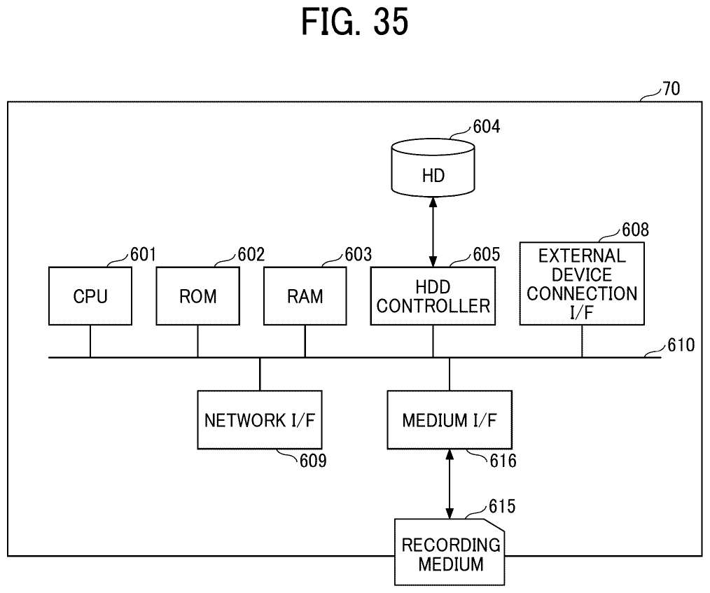

FIG. 34 is a diagram illustrating a configuration of a display system 100. The display system 100 includes the device 2 and an information processing apparatus 70 that communicate with each other via a network N.

The device 2 is located in a facility such as a company and is connected to a LAN or Wi-Fi installed in the facility. The information processing apparatus 70 is located in, for example, a data center. The device 2 is connected to an Internet i through a firewall 8, and the information processing apparatus 70 is also connected to the Internet i via, for example, a high-speed LAN in the data center.

The device 2 may be connected to the Internet i using wireless communication such as a mobile phone network. In this case, the wireless communication may be, for example, the third generation (3G), the fourth generation (4G), the fifth generation (5G), Long Term Evolution (LTE), or Worldwide Interoperability for Microwave Access (WiMAX).

The information processing apparatus 70 is implemented by one or more information processing apparatuses, and the one or more information processing apparatuses serve as servers to provide the device 2 with services. A server is a computer or software that performs the function of providing information or a processing result in response to a request from a client. As will be described later, the information processing apparatus 70 receives distance image data and image data captured by the finger photographing cameras from the device 2, and transmits information on pointing position coordinates to the device 2.

The configuration of the device 2 may be the same as that of the first embodiment, but it is sufficient that the device 2 includes a touch panel, the display 3, and a communication function in the following description. The device 2 may include multiple computing devices that communicate with one another.

In the following description, a general-purpose information processing apparatus such as a PC or a tablet terminal executes a web browser or a dedicated application. The web browser or the dedicated application communicates with the information processing apparatus 70. In the case where the web browser is executed, the operator inputs or selects the uniform resource locator (URL) of the information processing apparatus 70 so that the device connects to the information processing apparatus 70. The device 2 executes a web application provided by the information processing apparatus 70 using the web browser. The web application refers to software or a mechanism that is executed on the web browser and operates when a program on the web browser and a program on the web server operate in cooperation with each other. The program on the web browser may be described in a programming language for the web browser such as JAVASCRIPT.

In the case where the dedicated application is executed, the device uses the URL registered in advance to connect to the information processing apparatus 70. The dedicated application includes a program and a user interface. The program transmits and receives information to be used to and from the information processing apparatus 70, and causes the user interface to display the information.

As a communication method, a general-purpose communication protocol such as a hypertext transfer protocol (HTTP), a hypertext transfer protocol secure (HTTPS), or WebSocket may be used, or a dedicated communication protocol may be used.

### Hardware Configuration

The hardware configuration of the device 2 may be the same as that illustrated in FIG. 8. In the following description, a hardware configuration of the information processing apparatus 70 is described.

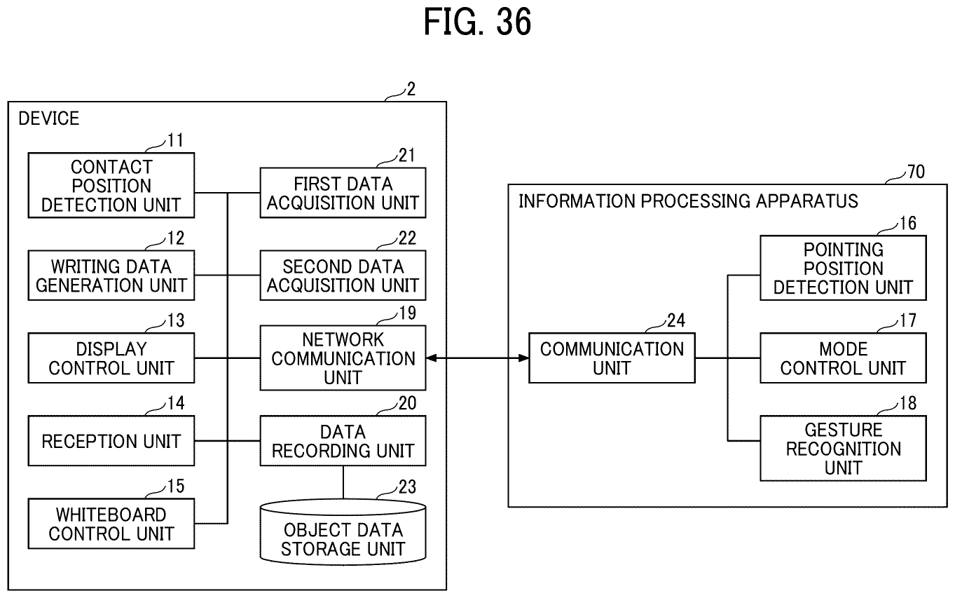

FIG. 35 is a block diagram illustrating a hardware configuration of the information processing apparatus 70. As illustrated in FIG. 35, the information processing apparatus 70 is implemented by a computer, and includes a CPU 601, a ROM 602, a RAM 603, an HD 604, a hard disk drive (HDD) controller 605, an external device connection I/F 608, a network I/F 609, a bus line 610, and a medium I/F 616.

The CPU 601 controls the entire operation of the information processing apparatus 70. The ROM 602 stores a program such as an IPL used for booting the CPU 601. The RAM 603 is used as a work area for the CPU 601. The HD 604 stores various data such as a program. The HDD controller 605 controls the reading and writing of data from and to the HD 604 under the control of the CPU 601. The external device connection I/F 608, which may be implemented by an interface circuit, is an interface that controls communication of data with various external devices. Examples of the external devices include, but not limited to, a USB memory and a printer. The network I/F 609, which may be implemented by an interface circuit, is an interface that controls data communication through a communication network. The bus line 610 is, for example, an address bus or a data bus that electrically connects the elements illustrated in FIG. 35, such as the CPU 601, with one another.

The medium I/F 616, which may be implemented by an interface circuitry, controls the reading and writing (storing) of data from and to a recording medium 615 such as a flash memory.

### Functions of System

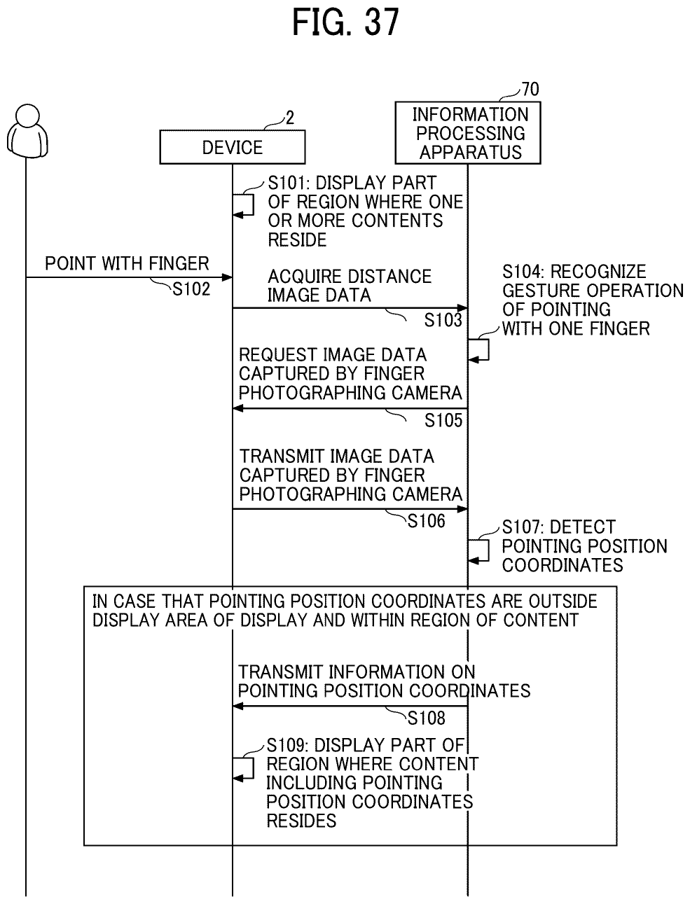

With reference to FIG. 36, a functional configuration of the display system 100 is described below. FIG. 36 is a block diagram illustrating a functional configuration of the display system 100. The differences from FIG. 9 are described below with reference to FIG. 36.

In the following description, the device 2 includes the contact position detection unit 11, the writing data generation unit 12, the display control unit 13, the reception unit 14, the whiteboard control unit 15, the network communication unit 19, the data recording unit 20, the first data acquisition unit 21, the second data acquisition unit 22, and the object data storage unit 23.

### Functions of Information Processing Apparatus

The information processing apparatus 70 includes a communication unit 24, the pointing position detection unit 16, the mode control unit 17, and the gesture recognition unit 18. These functional units of the information processing apparatus 70 are implemented by or caused to function by one or more of the hardware components illustrated in FIG. 35 operating in accordance with instructions from the CPU 601 according to the control program loaded from the HD 604 to the RAM 603.

The communication unit 24 receives distance image data and image data captured by the finger photographing cameras from the device 2, and transmits information on pointing position coordinates to the device 2. The other functions are substantially the same as those in the first embodiment. Even if some functions are different from those in the first embodiment, the differences do not affect the description of the present embodiment.

### Operation or Process

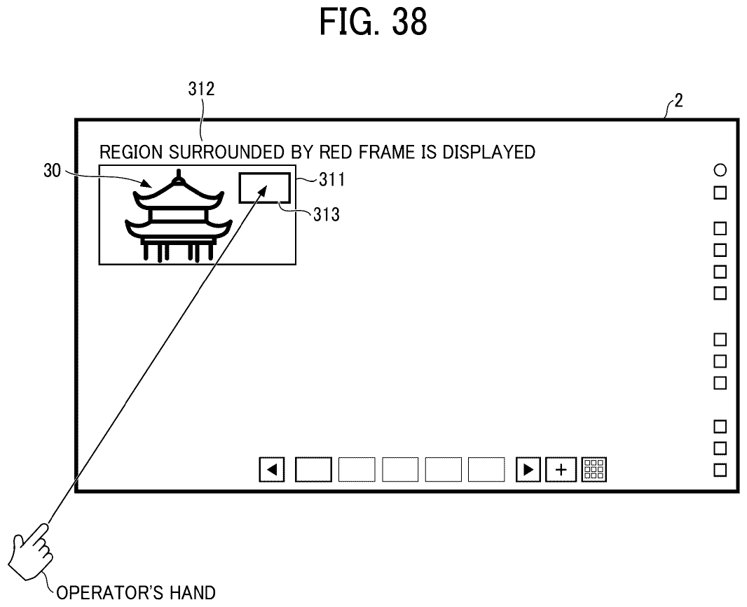

FIG. 37 is a sequence diagram illustrating a process in which the device 2 and the information processing apparatus 70 communicate with each other to display a region at a position pointed to by the operator with the finger.

In step S101, the device 2 controls the display 3 to display a part of a region where one or multiple contents are present in response to an operation performed by the operator. In step S102, the operator points to the outside of the display 3 with one finger.

In step S103, the second data acquisition unit 22 acquires distance image data from the distance image sensor 460. The network communication unit 19 transmits the distance image data to the information processing apparatus 70.

In step S104, the communication unit 24 of the information processing apparatus 70 receives the distance image data. Then, the gesture recognition unit 18 analyzes the distance image data. The gesture recognition unit 18 determines whether a gesture operation of pointing with one finger is recognized. It is assumed that a gesture operation of pointing with one finger is recognized.

In step S105, the communication unit 24 requests the device 2 to transmit image data captured by the finger photographing cameras.

In step S106, the network communication unit 19 receives the request and transmits the pieces of image data acquired by the first data acquisition unit 21 from the finger photographing camera (right) 471 and the finger photographing camera (left) 472, respectively, to the information processing apparatus 70.

In step S107, the communication unit 24 of the information processing apparatus 70 receives the pieces of image data. Then, the pointing position detection unit 16 detects pointing position coordinates of the position pointed to by the one finger. The pointing position detection unit 16 determines whether the pointing position coordinates are outside the display and within the region of the content 30. It is assumed that the pointing position detection unit 16 determines that the pointing position coordinates are outside the display and within the region of the content 30.

In step S108, the communication unit 24 of the information processing apparatus 70 transmits information on the pointing position coordinates to the device 2.

In step S109, the network communication unit 19 of the device 2 receives the information on the pointing position coordinates. Then, the display control unit 13 acquires image data corresponding to a rectangular region of 1920 pixels in the width direction and 1080 pixels in the height direction with the pointing position coordinates as the center in the region of the content 30, and copies the image data to the display memory area. The display control unit 13 further controls the display 3 to display an image based on the image data stored in the display memory area. In this way, the region of the content displayed in the display area of the display 3 is switched.

According to the present embodiment, in addition to the effect of the first embodiment, the device 2 connected to a network can display a content outside the area of the display 3 in response to a gesture operation. In the present embodiment, the case applied to the first embodiment has been described, but the case can also be suitably applied to the second to fourth embodiments.

### Seventh Embodiment

In the present embodiment, a case is described, in which when the display area displayed based on the coordinates of a position pointed to by the operator with the finger is not within the region where the content is present, the device 2 displays an image of the entirety of the content 30 in a reduced size and a message indicating that the content is not present.

In the description of the present embodiment, like reference signs are given to elements operate similarly and provide the same or similar effects in the first embodiment, and redundant descriptions may be omitted or only the differences may be described.

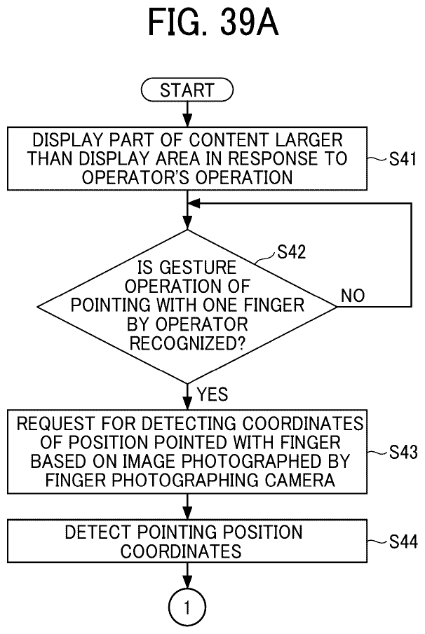

FIG. 38 is a diagram illustrating the display of the device 2 on which a pointing position illustration image 311 is displayed. The pointing position illustration image 311 is an image that clearly indicates the region of the entirety of the content 30, which is displayed in the display area in response to pointing to the position with the finger. The coordinates of the position pointed to by the operator with the one finger on the display 3 are sometimes significantly outside the region where the content 30 is present. In this case, the device 2 switches the display area to the display area centered on the coordinates of the position pointed to by the one finger, and then displays an image of the entirety of the content 30 in a reduced size and a message 312 indicating that the display area is outside the region of the content 30. The coordinates significantly outside the region where the content 30 is present means that the pixels of the content 30 are not present in the display area.

The same processes as those in the fourth embodiment are performed up to the determination that the pointing position coordinates T are outside the area of the display 3 and outside the region of the content 30. In the fourth embodiment, the edge region 61 in the direction of the pointing position coordinates T with respect to the origin is displayed. In the present embodiment, as in the first embodiment, the pointing position coordinates T are moved to the center position of the display of the device 2.

At this time, a condition is that no pixels of the content 30 are present in the display area. Therefore, the display area is blank. When the display area that is blank is displayed, the device 2 displays the pointing position illustration image 311 at the upper left corner (or upper right corner) of the display. The pointing position illustration image 311 includes the image of the entirety of the content 30 in the reduced size and an image (a rectangular frame 313) of the display area currently displayed on the display in a reduced size. The device 2 also displays the message 312 indicating that the display area is outside the region of the content 30. Even when the content 30 is not displayed at all, the operator can grasp which part of the periphery of the content is displayed in the display area with the rectangular frame 313.

The pointing position illustration image 311 and the message 312 indicating that the display area is outside the region of the content 30 are hidden when an operation such as handwriting input to the display 3 is performed or when the display position is changed in response to another pointing with a finger. Further, even when the operator does not perform any operation, the pointing position illustration image 311 and the message 312 indicating that the display area is outside the region of the content 30 are hidden after a certain period of time (e.g., 5 seconds) elapses.

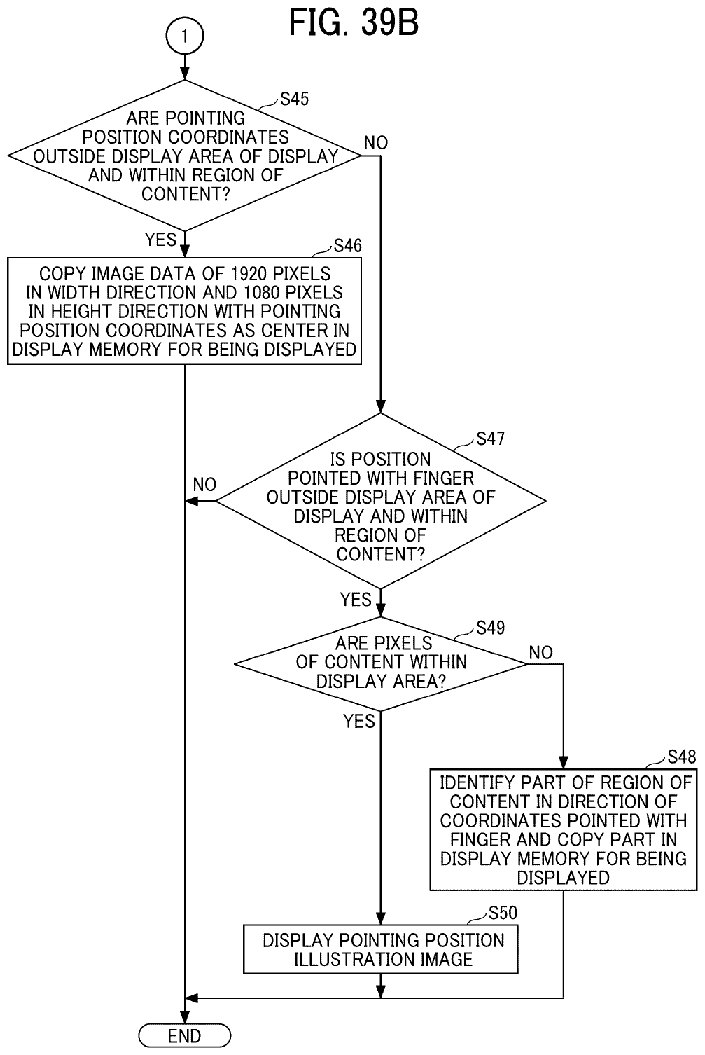

FIGS. 39A and 39B are flowcharts of another process for displaying a region outside the display area in the display area in response to a gesture operation performed by the operator. The differences from FIG. 23 are described below with reference to FIGS. 39A and 39B. In FIG. 39B, the processes of steps S49 and S50 are added.

In the case where the result of the determination in step S47 is Yes (YES in step S47), in step S49, the pointing position detection unit 16 determines whether the pixels of the content 30 are present in the display area centered on the pointing position coordinates. In other words, the pointing position detection unit 16 determines whether the pixels of the content are present in a rectangular region of 1920 pixels in the width direction and 1080 pixels in the height direction with the pointing position coordinates as the center.

In the case where the result of the determination in step S49 is Yes (YES in step S49), the process proceeds to step S50. In the case where the result of the determination in step S49 is No (NO in step S49), the process proceeds to step S48. The process of step S48 is the same as the process of step S48 in FIG. 23.

In step S50, the display control unit 13 controls the display 3 to display the pointing position illustration image 311 and the message 312 indicating that the display area is outside the region of the content 30 on the display area that is blank. In the pointing position illustration image 311, the rectangular frame 313 indicating the display area currently displayed on the display is presented.

According to the present embodiment, in addition to the effect of the first embodiment, even when the pointing position coordinates of a position pointed to by the operator with one finger are significantly outside the region of the content 30, the pointing position illustration image 311 and the rectangular frame 313 indicating the display area currently displayed on the display are displayed. Thus, even when the content 30 is not displayed at all, the operator can grasp which part of the periphery of the content is displayed in the display area.

### Applied Cases

The embodiments described above are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

For example, in the embodiments described above, the device 2 transitions to the gesture recognition mode when recognizing the palm of the hand in the initial state. However, the way of transitioning to the gesture recognition mode is not limited thereto. The device 2 may transition to the gesture recognition mode when recognizing a predetermined shape of an object or recognizing a predetermined movement of an object.

For example, in the embodiments described above, the pointing position coordinates are detected by the device 2 analyzing the pieces of image data captured by the finger photographing camera (right) 471 and the finger photographing camera (left) 472, respectively. However, the device 2 may detect the pointing position coordinates by analyzing the distance image data captured by the distance image sensor 460. As a way to achieve the aforementioned method, for example, a model that has learned the correspondence between distance image data and pointing position coordinates by deep learning can be used.

The content may be a moving image. In this case, although the image of the region including the pointing position coordinates changes with time, the device 2 only needs to display the region including the pointing position coordinates on the display 3.

The device 2 may be referred to, in addition to the electronic whiteboard, as an electronic information board or an interactive board. The embodiments described above can be suitably applied not only to an electronic whiteboard but also to any information processing apparatus having a touch panel. Examples of the information processing apparatus having a touch panel include a PC, a tablet terminal, and a smartphone each having a touch panel. These are general-purpose information processing apparatuses. However, when an application that functions as the device is executed on any one of the information processing apparatuses, the operator can operate the information processing apparatus as the device 2.

Alternatively, the device 2 may include a projector that projects a video. In this case, the device 2 detects coordinates of a position pointed to with a finger using the method described in the embodiments described above, and the projector projects a region including the coordinates of the position.

In the embodiments described above, the device 2 recognizes a gesture operation and detects coordinates of a position pointed to by the operator with one finger. However, at least one of the recognition of the gesture operation and the detection of the coordinates may be performed by a server apparatus connected to the device 2 through a network. In this case, the device 2 transmits the pieces of image data captured by the finger photographing camera (right) 471 and the finger photographing camera (left) 472, respectively, and the distance image data captured by the distance image sensor 460 to the server apparatus in real time. The server apparatus transmits information on the recognized gesture operation and the detected coordinates to the device 2. In this way, the processing load on the device 2 is reduced.

In the embodiments described above, the device 2 detects the coordinates of a position pointed to by the index finger, but the coordinates of a position may be pointed to by another finger.

The functional configuration illustrated in, for example, FIG. 9 is divided according to functions in order to facilitate understanding of the processing units executed by the device 2. No limitation to the scope of the present disclosure is intended by how the processing units are divided or by the names of the processing units. The processing units executed by the device 2 may be divided into a greater number of processing units in accordance with the contents of the processing units. In addition, a single processing unit can be divided to include a greater number of processing units.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

Embodiments of the present disclosure provide significant improvements in computer capabilities and functionality. These enhancements allow operators to take advantage of computers that provide more efficient and robust interaction with tables, which is a way to store and present information on information processing apparatuses. Further, embodiments of the present disclosure provide a better user experience through the use of a more efficient, powerful, and robust user interface. Such a user interface provides a better interaction between a human and a machine.

Any one of the above-described operations may be performed in various other ways, for example, in an order different from the one described above.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

In another aspect, a device includes circuitry to display a content on an external display, detect coordinates of a position pointed to by a pointing object, and control the external display to display a part of a region where the content having the coordinates is present in a case that the coordinates are outside a display area of the external display and within the region.

1. A device comprising circuitry configured to:
detect coordinates of a position pointed to by a pointing object; and
control a display to display a part of a region where a content having the coordinates is present in a case that the coordinates are outside a display area of the display and within the region of the content.

2. The device according to claim 1,
wherein the circuitry is configured to control the display to keep displaying the part of the region for a certain period of time after controlling the display to display the part of the region even in a case that other coordinates of a position pointed to by the pointing object are detected outside the display area of the display and within the region.

3. The device according to claim 2,
wherein the circuitry is further configured to:
acquire image data obtained by photographing the pointing object and the display of the device;
track the pointing object based on a feature amount of the pointing object obtained from the image data; and
in a case that the other coordinates of the position pointed to by a same pointing object as the pointing object being tracked are detected outside the display area of the display and within the region within the certain period of time after controlling the display to display the part of the region, control the display to display the part of the region.

4. The device according to claim 1,
wherein the circuitry is configured to control the display to display another region that is centered on a line connecting a center of the display and the coordinates and is located at an edge of the region in a case that other coordinates of a position pointed to by the pointing object are detected outside the display area of the display and outside the region.

5. The device according to claim 1,
wherein the circuitry is configured to, in a case that no pixels of the content are present in a display area centered on the coordinates, control the display to display an image of an entirety of the content in a reduced size and a frame indicating another region displayed on the display out of the entirety of the content, and further control the display to display information indicating that the display area is outside the region of the content.

6. A display method comprising:
detecting coordinates of a position pointed to by a pointing object; and
controlling a display to display a part of a region where a content having the coordinates is present in a case that the coordinates are outside a display area of the display and within the region.

7. A non-transitory recording medium storing a plurality of program codes which, when executed by one or more processors, causes the one or more processors to perform the method according to claim 6.

8. A display system comprising:
a device; and
an information processing apparatus communicably connected with the device,
the device including circuitry configured to:
display a content on a display;
acquire information for detecting a pointing operation performed by a pointing object; and
transmit the information to the information processing apparatus via a network, and
the information processing apparatus including another circuitry configured to:
analyze the information received from the device;
detect coordinates of a position pointed to by the pointing object performing the pointing operation; and
transmit information on the coordinates to the device in a case that the coordinates are outside a display area of the display and within a region where the content having the coordinates is present,
wherein the circuitry is configured to control the display to display a part of the region where the content having the coordinates is present, the coordinates being included in the information received from the another circuitry.
